(19) United States
(12) Patent Application Publication
(10) Pub. No.: US 2026/0034817 A1
(43) Pub. Date: Feb. 5, 2026

(54) PRINTER RIBBON ORIENTATION SYSTEM AND METHOD

(71) Applicant: Brady Worldwide, Inc., Milwaukee, WI (US)

(72) Inventors: Aaron P. Ordoña, Singapore (SG); Mui Heng Too, Singapore (SG)

(21) Appl. No.: 18/790,117

(22) Filed: Jul. 31, 2024

(51) Int. Cl. B41J 33/00; B41J 2/325; B41J 11/04; B41J 29/387; B41J 35/38

(52) U.S. Cl. CPC B41J 33/003; B41J 2/325; B41J 11/04; B41J 29/387; B41J 35/38

(57) ABSTRACT

The present disclosure is directed to a system for preventing incorrect installation of ribbon material in a printer. The system includes a spindle rotatable in a first direction or a second direction. The spindle is capable of supporting a supply of ribbon material for rotation with the spindle. The system also includes a trigger associated with the spindle. The trigger rotates with the spindle in the first direction or the second direction. The system further includes an actuator adjacent the spindle and configured to detect whether the spindle is rotating in the first direction or the second direction via the trigger.

### CROSS-REFERENCE TO RELATED APPLICATIONS

None.

### BACKGROUND

Thermal transfer printers employ a digital printing method that uses a ribbon and a printhead to selectively transfer ink onto a substrate (e.g., paper or another form of printable media). This method is known in the art to produce high-quality, high-resolution, durable prints. For example, thermal transfer printers are commonly used to print labels (e.g., barcodes) that will be used for long-term applications or that will be exposed to harsh conditions such as heat, ultraviolet light, moisture, and chemicals. Thermal transfer printers are also capable of handling high-volume print jobs in an efficient and cost-effective manner. For these and other reasons, thermal transfer printers are commonplace in a variety of industries including retail, healthcare, manufacturing, and others.

However, incorrect installation of the ribbon material can interfere with the operation of the printer and, in some cases, cause damage to the printhead or other internal components of the printer. For example, ribbon rolls are typically installed on a spindle within the printer, and the spindle supports the ribbon roll for rotation thereabout as the ribbon material is uncoiled from the roll and consumed during printing operations. In this context, the ribbon roll can be installed in a first orientation (e.g., arranged to rotate about the spindle in a first direction) or in a second orientation (e.g., arranged to rotate about the spindle in a second direction). Only one side of the ribbon material is coated with ink—the other side is blank. Therefore, installing the ribbon roll with the correct orientation is critical.

During printing, the ribbon material and the substrate are guided to a location where they converge beneath the printhead with the ink-coated side of the ribbon material facing the substrate and the blank side of the ribbon material facing the printhead. Thus, the printhead applies heat to the blank side of the ribbon material, thereby melting at least a portion of the ink on the ink-coated side and transferring the melted ink to the substrate. When the ribbon roll is installed with the incorrect orientation, the printhead applies heat directly to the ink-coated side of the ribbon material and the blank side of the ribbon material faces the substrate. Therefore, ink will not be transferred to the substrate and the printer will produce blank printouts. Additionally, the ink melted from the ink-coated side of the ribbon material may be unintentionally transferred to the functional surface of the printhead and can cause damage to the printhead or other components of the printer.

Some mechanisms have been devised to prevent such undesirable outcomes, though existing solutions introduce additional problems. For example, some devices utilize a series of sensors mounted along the ribbon path to detect whether the ink-coated side of the ribbon material is oriented correctly. However, these sensors introduce multiple potential points of failure and increase the cost of producing and purchasing the printer. Other devices utilize mechanical covers or plates as an intuitive guide for a user installing a ribbon roll. However, such mechanical features still leave open the possibility of user error leading to incorrect installation of the ribbon material.

Thus, a need exists for a mechanism capable of ensuring that ribbon material is installed correctly (e.g., a ribbon orientation mechanism for preventing incorrect installation) in a manner that is cost-effective and eliminates or reduces the possibility of user error.

### SUMMARY

The present systems and methods disclosed herein overcome many of the shortcomings and limitations of the prior art devices discussed above.

In one aspect, a ribbon orientation system for a printer is disclosed. The ribbon orientation system includes a spindle rotatable in a first direction or a second direction. The spindle is capable of supporting a supply of ribbon material for rotation therewith. The ribbon orientation system also includes a flag associated with the spindle. The flag rotates with the spindle in the first direction or the second direction. The ribbon orientation system further includes a sensor positioned adjacent the spindle and configured to detect whether the spindle is rotating in the first direction or the second direction via the flag.

In another aspect, a ribbon orientation system for a printer is disclosed. The ribbon orientation system includes a ribbon supply spindle and a supply of ribbon material capable of being installed on the ribbon supply spindle in a first orientation or a second orientation. The ribbon material includes an ink-coated side and a blank side. The ribbon orientation system further includes a sensor positioned proximate to the ribbon supply spindle and configured to detect whether the supply of ribbon material is installed in the first orientation or the second orientation.

In a further aspect, a method for determining whether a supply of ribbon material is installed on a spindle of a printer correctly is disclosed. The method includes the step of providing a ribbon orientation mechanism. The ribbon orientation mechanism includes a sensor capable of being in a blocked position or an unblocked position and a flag disposed on the spindle. The flag is capable of rotating in a first direction or a second direction. The flag causes the sensor to be in a blocked position when the flag rotates in the first direction and the flag causes the sensor to be in an unblocked position when the flag rotates in the second direction. The method also includes the steps of receiving the supply of ribbon material on the spindle, rotating the spindle, and determining whether the sensor is in the unblocked position or block position. In response to a determination that the sensor is in the unblocked position, an error message is displayed.

### BRIEF DESCRIPTION OF THE DRAWINGS

FIG. 1 illustrates a front, top, and left side isometric view of an exemplary printer in a closed configuration;

FIG. 2 illustrates a front, top, and right side isometric view of the printer of FIG. 1 in an open configuration;

FIG. 3A illustrates a front, top, and right side isometric view of several components of the printer of FIGS. 1 and 2 including a ribbon roll in a first, correct orientation;

FIG. 3B illustrates a front, top, and right side isometric view of several components of the printer of FIGS. 1 and 2 including a ribbon roll in a second, incorrect orientation;

FIG. 4 illustrates a top and right side isometric view of a spindle for use with the printer of FIGS. 1 and 2;

FIG. 5 illustrates a front, top, and left side isometric view of a mounting wall of the printer of FIGS. 1 and 2;

FIG. 6 illustrates a rear isometric, enlarged view of a portion of the mounting wall of FIG. 5;

FIG. 7 illustrates an isometric view of a bearing for use with the mounting wall of FIG. 5;

FIG. 8 illustrates a rear, top, and left side isometric, enlarged view of a portion of the mounting wall of FIG. 5 with the spindle of FIG. 4 installed thereon;

FIG. 9 illustrates a left side elevational, cross-sectional view of the spindle of FIG. 4 installed on the mounting wall of FIG. 5, taken along the line 9-9 of FIG. 8;

FIG. 10 illustrates a rear isometric, enlarged view of a portion of the mounting wall of FIG. 5 with the spindle of FIG. 4 installed thereon and an exemplary ribbon orientation system for use with the printer of FIGS. 1 and 2 constructed according to the principles of the present disclosure;

FIG. 11 illustrates a rear, top, and left side isometric view of an actuator of the ribbon orientation system of FIG. 10;

FIG. 12 illustrates a left side elevational view of the actuator of FIG. 11;

FIG. 13 illustrates a front elevational view of a trigger of the ribbon orientation system of FIG. 10;

FIG. 14 illustrates a front and right side isometric view of the trigger of FIG. 13;

FIG. 15 illustrates a front elevational view of a connection ring of the ribbon orientation system of FIG. 10;

FIG. 16 illustrates a front elevational view of the trigger of FIG. 13 with the connection ring of FIG. 15 positioned thereon;

FIG. 17 illustrates a front, bottom, and right side isometric view of a gear unit of the ribbon orientation system of FIG. 10;

FIG. 18 illustrates a front elevational view of the gear unit of FIG. 17;

FIG. 19 illustrates a rear, top, and right side isometric view of the gear unit of FIG. 17 with a slip ring positioned therein;

FIG. 20 illustrates a rear and right side isometric view of the slip ring of FIG. 19;

FIG. 21 illustrates a right side elevational view of the spindle of FIG. 4, a portion of the mounting wall of FIG. 5, the ribbon orientation system of FIG. 10, the gear unit of FIG. 17, and the slip ring of FIG. 19 configured for operation;

FIG. 22 illustrates a right side elevational, cross-sectional view of the spindle of FIG. 4, a portion of the mounting wall of FIG. 5, the ribbon orientation system of FIG. 10, the gear unit of FIG. 17, and the slip ring of FIG. 19 configured for operation, taken along the line 22-22 of FIG. 21;

FIG. 23 illustrates a rear, top, and left side isometric view of the spindle of FIG. 4, a portion of the mounting wall of FIG. 5, the ribbon orientation system of FIG. 10, the gear unit of FIG. 17, and the slip ring of FIG. 19 configured for operation;

FIG. 24 illustrates a schematic view of several components of the printer of FIGS. 1 and 2 including a ribbon roll in a third, correct orientation and a spindle with another exemplary ribbon orientation system for use with the printer of FIGS. 1 and 2 constructed according to the teachings of the present disclosure connected thereto;

FIG. 25 illustrates a front elevational view of the ribbon orientation system of FIG. 24 in a first configuration corresponding to the third, correct orientation of the ribbon roll;

FIG. 26 illustrates a schematic view of several components of the printer of FIGS. 1 and 2 including a ribbon roll in a fourth, incorrect orientation and the spindle and the ribbon orientation system of FIG. 24;

FIG. 27 illustrates a front elevational view of the ribbon orientation system of FIG. 24 in a second configuration corresponding to the fourth, incorrect orientation of the ribbon roll;

FIG. 28 illustrates a front elevational view of an additional exemplary ribbon orientation system for use with the printer of FIGS. 1 and 2 constructed according to the principles of the present disclosure in a first configuration.

FIG. 29 illustrates a front elevational view of the ribbon orientation system of FIG. 28 in a second configuration; and

FIG. 30 is a flowchart illustrating a method for determining whether a supply of ribbon material is installed on a spindle of a printer correctly.

### DETAILED DESCRIPTION

Before any embodiments are described in detail, it is to be understood that the disclosure is not limited in its application to the details of construction and the arrangement of components set forth in the following description or illustrated in the following drawings, which is limited only by the claims that follow the present disclosure. The disclosure is capable of other embodiments, and of being practiced, or of being carried out, in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the disclosure.

Additionally, while the following discussion may describe features associated with specific devices or embodiments, it is understood that additional devices and/or features can be used with the described systems and methods, and that the discussed devices and features are used to provide examples of possible embodiments, without being limited.

The present disclosure is directed to a system designed to detect when a supply or roll of ribbon material is installed incorrectly. The system may be configured to take corrective action in response to detecting incorrect installation (e.g., by generating an error message for a user or by temporarily disabling or stopping operation of the printer). In some instances, the system may utilize an actuator and a trigger arranged to engage the actuator depending on the rotational position of the trigger. For example, the trigger may be arranged to rotate with the spindle retaining the supply of ribbon material. The trigger may engage the actuator when the spindle rotates in a first direction but may not engage the actuator when the spindle rotates in a second direction. Thus, the actuator may be in communication with a processor or controller of the printer so that printing operations may only be performed when an acceptable operating condition is detected.

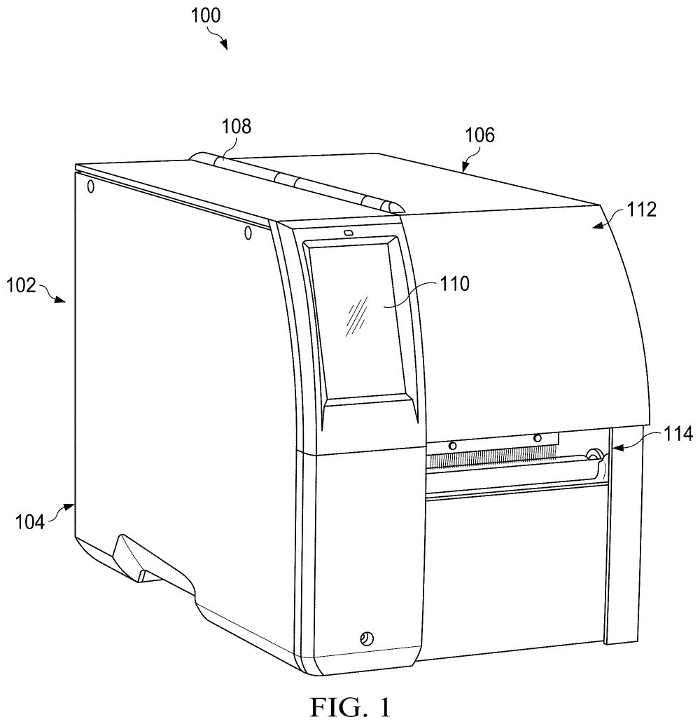

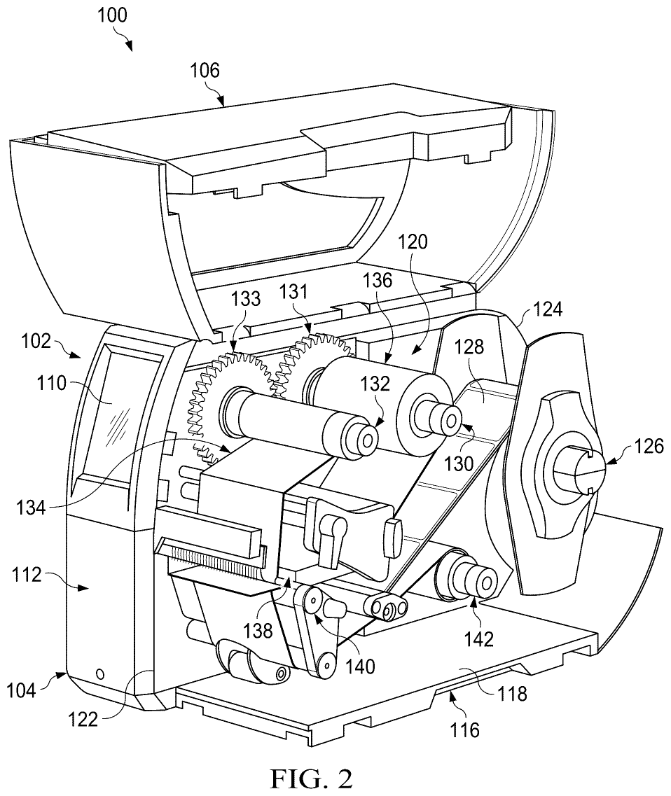

Referring first to FIGS. 1 and 2, an exemplary thermal transfer printer 100 is provided in the form of a housing 102 defining a base portion 104 and an enclosure cover 106. The base portion 104 and the enclosure cover 106 may be hingedly attached or otherwise coupled to one another such that the enclosure cover 106 may be removably opened and/or attached to allow access to the internal components of the printer 100 and to allow for installation or maintenance of the internal parts. For example, the enclosure cover 106 may be coupled to the base portion 104 via a hinge 108.

A user interface 110 may be located on a front face 112 of the printer 100. The user interface 110 may allow users to operate, service, or otherwise interface with the printer 100. For example, the user interface 110 may enable users to alter certain settings or preferences with respect to one or more print jobs. Additionally, the printer 100 may include an exit slot 114 provided in the form of a rectilinear opening between the base portion 104 and the enclosure cover 106 disposed on the front face 112. The exit slot 114 may provide an aperture through which printed media produced by the printer 100 may exit the printer 100, e.g., to be retrieved by a user.

As shown in FIG. 2, the enclosure cover 106 of the printer 100 is designed to move into an open configuration. In some instances, the enclosure cover 106 may be rotatable about an axis of connection with the base portion 104 formed by the hinge 108. Thus, a user may place the printer 100 in the open configuration by lifting the enclosure cover 106 away from the base portion 104 and causing the enclosure cover 106 to rotate about the hinge, thereby exposing one or more internal components of the printer 100.

The base portion 104 may include a chassis 116 configured to support one or more internal components of the printer 100. The chassis 116 may be provided in the form of a floor 118 and a mounting wall 120 oriented in a plane that is substantially perpendicular to the floor 118. The mounting wall 120 may be formed integrally with or coupled to the floor 118 and extend upwardly therefrom. The mounting wall 120 may be defined by a front end 122 (the front end 122 corresponding to the front face 112 of the printer 100) and a rear end 124 opposing the front end 122. In some instances, the chassis 116 may be formed from cast aluminum. In other instances, the chassis 116 may be formed from any other suitable material.

Internal components of the printer 100 may be connected to the mounting wall 120 of the chassis 116. For example, a media holder 126 may be connected to the mounting wall 120 and may be positioned adjacent to the rear end 124 of the chassis 116. The media holder 126 is designed to retain and dispense a supply of printable media 128 (e.g., adhesive labels or any other suitable media) from a roll as the printer 100 operates. The media holder 126 may be configured to support printable media 128 of different sizes (e.g., labels having different widths).

The chassis 116 may also support a ribbon supply spindle 130 and a waste ribbon spindle 132 connected to the mounting wall 120. The ribbon supply spindle 130 may be positioned on the mounting wall 120 proximate to the media holder 126, and the waste ribbon spindle 132 may be positioned between the ribbon supply spindle 130 and the front end 122 of the mounting wall 120.

The ribbon supply spindle 130 may include a ribbon supply spindle gear member 131 and the waste ribbon spindle 132 may include a waste ribbon spindle gear member 133. The ribbon supply spindle gear member 131 and the waste ribbon spindle gear member 133 may be configured to be engaged by a driven component (not shown) of the printer 100 such that the driven component may generate rotation of the ribbon supply spindle 130 and the waste ribbon spindle 132, respectively.

The ribbon supply spindle 130 is designed to retain and dispense a supply of ribbon material 134 from a ribbon roll 136 (e.g., in a manner similar to the media holder 126) as the printer 100 operates. During the printing process, printable media 128 from the media holder 126 and ribbon material 134 from the ribbon supply spindle 130 may each be directed toward the front end 122 of the mounting wall 120. The printable media 128 and the ribbon material 134 may converge proximate to a printhead 138 and a platen roller 140. The printhead 138 and platen roller 140 may each be connected to the chassis 116 and positioned proximate to the front end 122 of the mounting wall 120. For example, the printhead 138 and platen roller 140 may be positioned on the mounting wall 120 so that the printhead 138 and platen roller 140 are positioned adjacent to the exit slot 114 when the enclosure cover 106 is placed in a closed configuration.

During printing, the printable media 128 and ribbon material 134 may pass between the printhead 138 and the platen roller 140. The printhead 138 may be configured to apply heat to the ribbon material 134 passing beneath the printhead 138, thereby causing ink from the ribbon material to melt and adhere to an adjacent portion of the printable media 128. At the same time, the platen roller 140 may be arranged to provide a smooth support surface to the printable media 128 and ribbon material 134 as they pass beneath the printhead 138 and come into contact with one another. For example, the platen roller 140 may apply a pressure against the printable media 128 and the ribbon material 134, thereby ensuring that each engages firmly with the printhead 138 such that ink from the ribbon material 134 is effectively transferred to the printable media 128.

Once the ink from the ribbon material 134 has been applied to the printable media 128 by the printhead 138, the printable media 128 may exit the printer 100 via the exit slot 114 and the ribbon material 134 may be directed to and collected on the waste ribbon spindle 132. In some instances, rather than exiting the printer 100 via the exit slot 114, the printable media 128 may be directed back toward the rear end 124 of the mounting wall 120 where the printable media 128 may be collected by a rewinder 142. In this way, the printer 100 may generate as an end product a supply of printed media (e.g., a roll of printed labels) to be later retrieved, or otherwise removed, by a user, rather than supplying the finished product directly to a user via the exit slot 114.

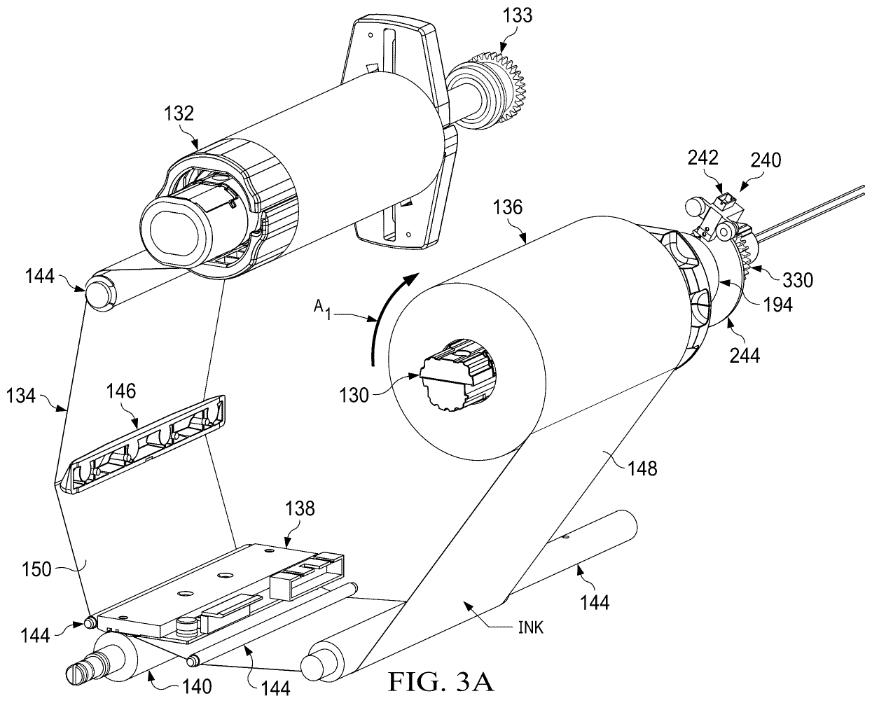

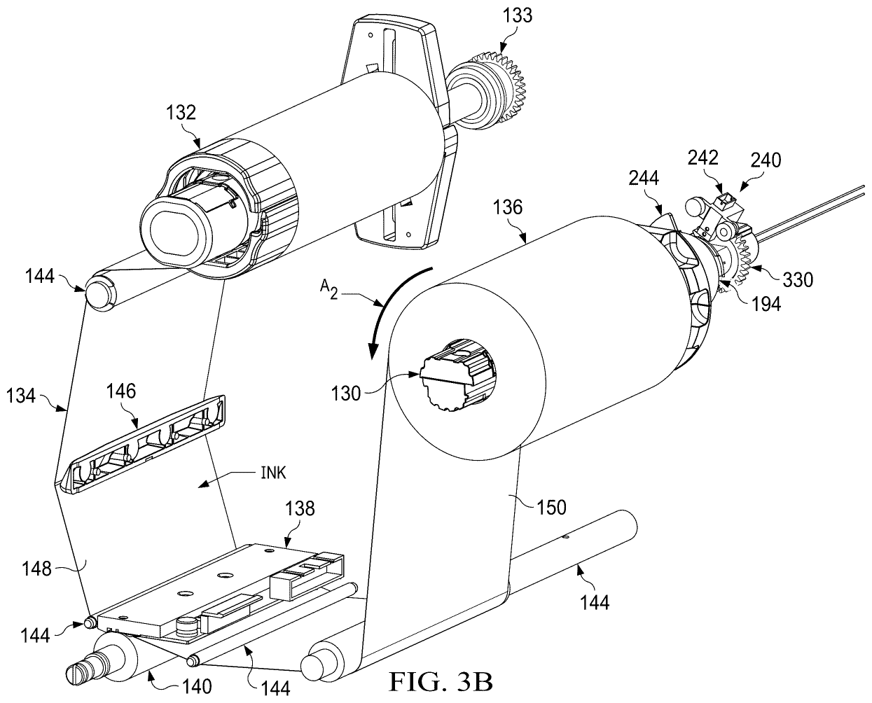

Turning to FIGS. 3A and 3B, the ribbon roll 136 can be installed in a first, correct orientation (e.g., FIG. 3A) or the ribbon roll 136 can be installed in a second, incorrect orientation (e.g., FIG. 3B). In some instances, the ribbon roll 136 may be arranged to rotate about the ribbon supply spindle 130 in a first direction (e.g., in the direction of the arrow A₁ of FIG. 3A) when installed in the first orientation and in a second direction (e.g., in the direction of the arrow A₂ of FIG. 3B) when installed in the second orientation.

In some instances, the printer 100 may include one or more rollers 144 and/or one or more diverters 146 arranged to deflect or guide the ribbon material 134 along a desired ribbon path that begins at the ribbon supply spindle 130, travels between the printhead 138 and platen roller 140, and terminates at the waste ribbon spindle 132. In some instances, the printer 100 may include four rollers 144 and one diverter 146 as shown in FIGS. 3A and 3B. In other instances, the printer 100 may include any number of rollers 144 and/or diverters 146, and the rollers 144 and diverters 146 may be arranged to guide the ribbon material 134 along any suitable path.

The ribbon material 134 may have an ink-coated side 148 and a blank side 150 opposite the ink-coated side. As shown in FIG. 3A, the ribbon roll 136 may be correctly installed in the first orientation such that the ribbon roll 136 rotates in the direction indicated by the arrow A₁ and the ink-coated side 148 is face down (e.g., facing the platen roller 140) when the ribbon material 134 is fed between the platen roller 140 and the printhead 138. Thus, the printhead 138 may apply heat to the blank side 150 of the ribbon material 134, thereby melting at least a portion of the ink from the ink-coated side 148 and causing the melted ink to be transferred to an adjacent portion of the printable media 128 (not shown) positioned between the platen roller 140 and the ink-coated side 148 of the ribbon material 134.

As shown in FIG. 3B, the ribbon roll 136 may be incorrectly installed in the second orientation such that the ribbon roll 136 rotates in the direction of the arrow A₂ and the ink-coated side 148 of the ribbon material 134 is face up (e.g., adjacent to the printhead 138) as the ribbon material 134 is fed between the platen roller 140 and the printhead 138. Thus, if printing operations are performed when the ribbon roll 136 is installed in the second orientation, the printhead 138 may apply heat directly to the ink-coated side 148. As a result, melted ink from the ink-coated side 148 may be unintentionally transferred to the functional surface of the printhead 138 and cause damage thereto. Moreover, incorrect installation may result in blank printouts because the blank side 150 of the ribbon material 134 may be positioned adjacent to the printable media 128 (not shown) when the ribbon material 134 and the printable media 128 come into contact.

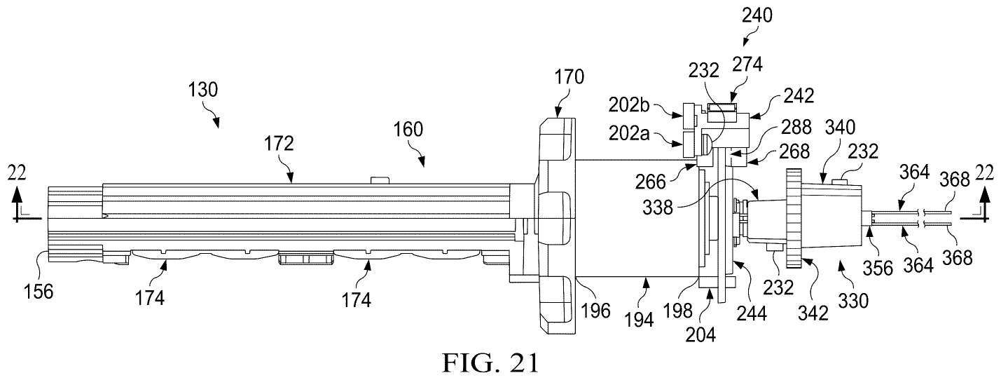

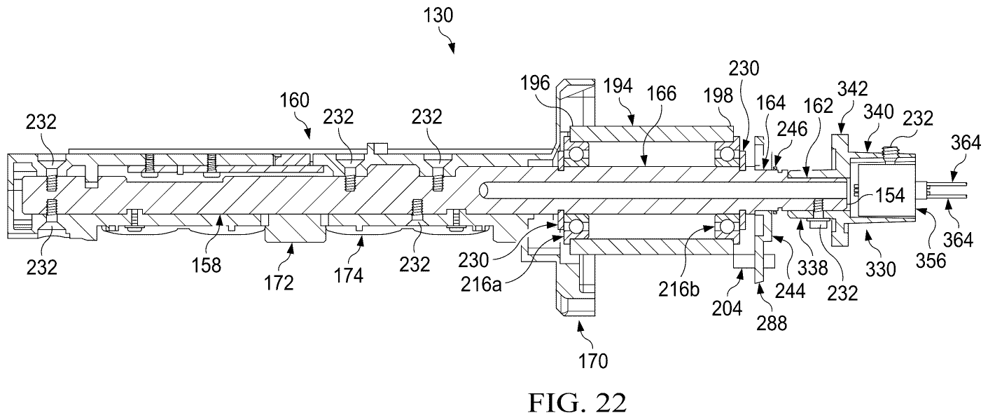

A ribbon orientation system 240 may be designed to detect whether the ribbon roll 136 is installed in the first orientation or the second orientation and to take corrective action as needed to avoid wasted materials and/or damage to the printer 100. For example, the ribbon orientation system 240 may be installed on or integrated with the ribbon supply spindle 130 and/or the mounting wall 120, as explained in detail below with reference to FIGS. 21 and 22.

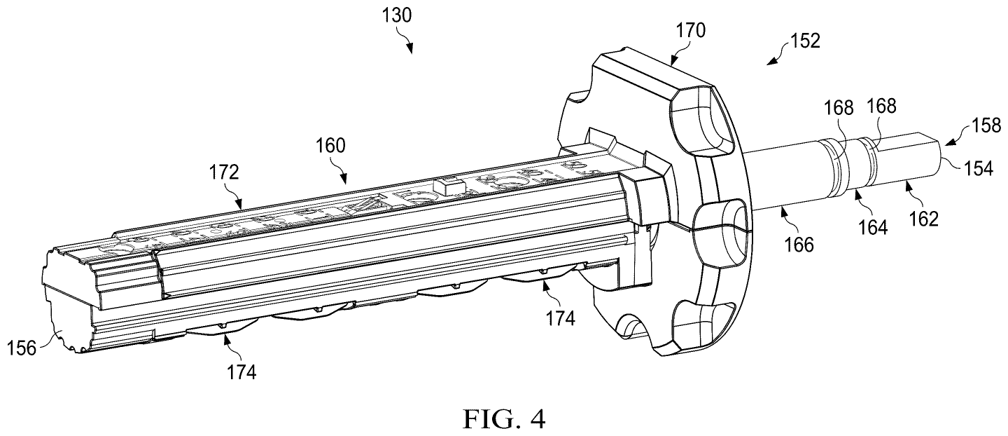

Turning to FIG. 4, the ribbon supply spindle 130 may be provided in the form of a substantially tubular spindle body 152 defined by a mounting end 154 and a receiving end 156 opposing the mounting end 154. The mounting end 154 may be configured to facilitate installation of the ribbon supply spindle 130 in a desired printing device (e.g., by facilitating attachment to the mounting wall 120 of the printer 100). The receiving end 156 may be configured to receive the ribbon roll 136 when the ribbon material 134 is installed.

The ribbon supply spindle 130 may include a substantially cylindrical shaft 158 and a substantially annular hub 160 encasing at least a portion of the shaft 158. A shaft notched portion 162 of the shaft 158 may be positioned adjacent to the mounting end 154 of the ribbon supply spindle 130. A substantially cylindrical shaft midsection 164 may be positioned adjacent to the shaft notched portion 162, and a substantially cylindrical shaft main body portion 166 may be positioned opposite the shaft midsection 164 such that a portion of the shaft main body portion 166 is embedded within the hub 160. The shaft 158 may include one or more annular grooves 168 designed to receive a washer or other similar part. For example, in some instances, a groove 168 may be positioned at the junction between the shaft notched portion 162 and the shaft midsection 164. In some instances, one or more grooves 168 may be positioned along the shaft main body portion 166. In other instances, any number of grooves 168 may be arranged along the shaft 158 in any suitable configuration.

The hub 160 may include a substantially circular spindle flange 170 and a substantially tubular spindle arm 172 connected to the spindle flange 170 and extending outwardly therefrom before terminating at the receiving end 156 of the ribbon supply spindle 130. The spindle arm 172 may be configured to retain the ribbon roll 136 while the printer 100 is in operation. In some instances, the spindle arm 172 may include one or more leaf springs 174 configured to engage a core (not shown) of the ribbon roll 136 when the ribbon roll 136 is installed. For example, the leaf springs 174 may restrict or prevent the ribbon roll 136 from rotating relative to the spindle arm 172 such that the ribbon roll 136 may rotate in unison with the ribbon supply spindle 130.

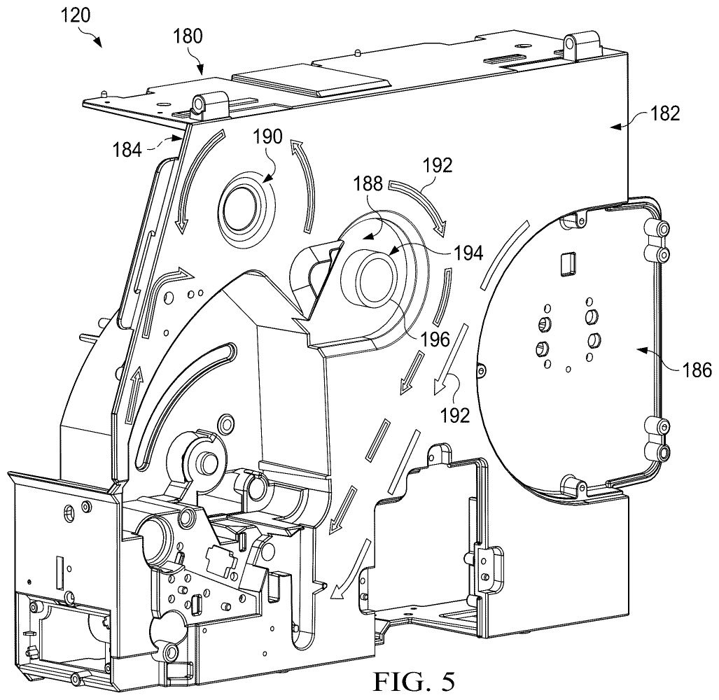

Turning to FIG. 5, in some instances, the mounting wall 120 may be provided in the form of a substantially rectilinear mounting wall body 180 defined by a mounting wall exterior surface 182 and a mounting wall interior surface 184 opposing the mounting wall exterior surface 182. The mounting wall 120 may include a media region 186 (e.g., to support the media holder 126), a ribbon supply region 188 (e.g., to support the ribbon supply spindle 130), and a ribbon take-up region 190 (e.g., to support the waste ribbon spindle 132). In some instances, one or more indicator symbols 192 may be provided as a visual guide on the mounting wall exterior surface 182 designed to aid users in installing consumables in the printer 100 (e.g., printable media 128, ribbon material 134, and/or other consumables).

The ribbon supply region 188 may include a spindle collar 194 provided in the form of an annular member extending entirely through the mounting wall body 180 and oriented substantially perpendicular with respect to the mounting wall exterior surface 182 and/or the mounting wall interior surface 184. In some instances, the spindle collar 194 may be formed integrally with the mounting wall 120. In other instances, the spindle collar 194 may be coupled to the mounting wall 120 at the ribbon supply region 188. The spindle collar 194 may include a spindle collar first end 196 extending beyond the mounting wall exterior surface 182.

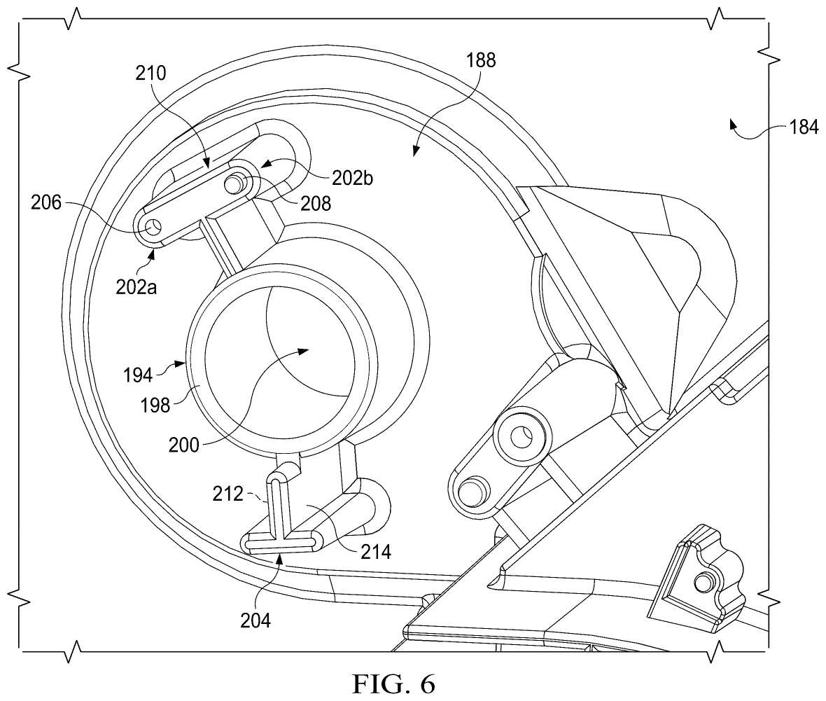

As best shown in FIG. 6, the spindle collar 194 may include a spindle collar second end 198 opposing the spindle collar first end 196 and extending beyond the mounting wall interior surface 184. The spindle collar 194 may define a substantially circular spindle opening 200 extending entirely between the spindle collar first end 196 and the spindle collar second end 198. In some instances, the spindle opening 200 may be configured to receive a portion of the ribbon supply spindle 130 (e.g., the shaft 158). The mounting wall 120 may also include one or more actuator mounting members 202 and one or more hardstops 204 connected to the mounting wall interior surface 184 proximate to the spindle collar 194 and extending outwardly therefrom.

In some instances, the mounting wall 120 may include a first actuator mounting member 202a including an actuator mounting hole 206 configured to receive a fastener (e.g., via threaded engagement) and a second actuator mounting member 202b including an actuator mounting pin 208 configured to be received by an associated opening (e.g., in a press fit). In some instances, an actuator mounting body 210 may extend between the first and second actuator mounting members 202a, 202b, but the first and second actuator mounting members 202a, 202b may also be provided in the form of independent protrusions connected to the mounting wall interior surface 184. In other instances, the mounting wall 120 may include any number of actuator mounting members 202 and the actuator mounting members 202 may be provided in any suitable form and arranged on the ribbon supply region 188 in any suitable configuration.

In some instances, the mounting wall 120 may include a hardstop 204 provided in the form of a T-shaped protrusion connected to the mounting wall interior surface 184 and extending outwardly therefrom. The hardstop 204 may extend beyond the mounting wall interior surface 184 by a greater distance than the spindle collar second end 198. The hardstop 204 may extend beyond the mounting wall interior surface 184 by a greater distance than the actuator mounting members 202. In some instances, the hardstop 204 may include a first impact surface 212 and a second impact surface 214 opposing the first impact surface 212 and the hardstop 204 may be positioned about the spindle collar 194 in a substantially opposing location with respect to the actuator mounting members 202. In other instances, the mounting wall 120 may include any number of hardstops 204 and the hardstops 204 may be provided in any suitable form and arranged on the ribbon supply region 188 in any suitable configuration.

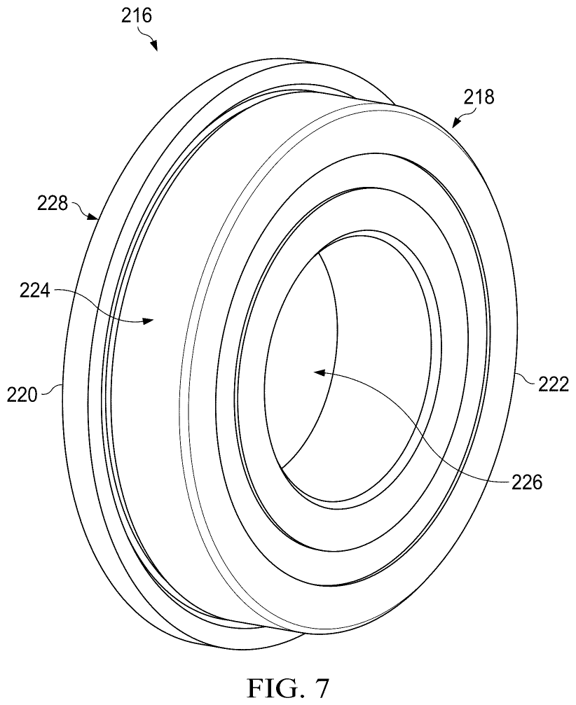

Turning to FIG. 7, one or more bearings 216 may facilitate installation of the ribbon supply spindle 130 on the mounting wall 120. For example, one or more bearings 216 may support a portion of the ribbon supply spindle 130 (e.g., the shaft 158) for rotation within the spindle collar 194. In some instances, each bearing 216 may be provided in the form of an annular bearing body 218 defined by a bearing first end 220, a bearing second end 222 opposing the bearing first end 220, and a substantially cylindrical bearing mating surface 224 extending at least partially between the bearing first end 220 and the bearing second end 222. The bearing body 218 may define a circular bearing opening 226 extending entirely therethrough (e.g., configured to receive the shaft 158) and may include a circular bearing lip 228 coupled to the first end of the bearing body 218 and extending outwardly therefrom.

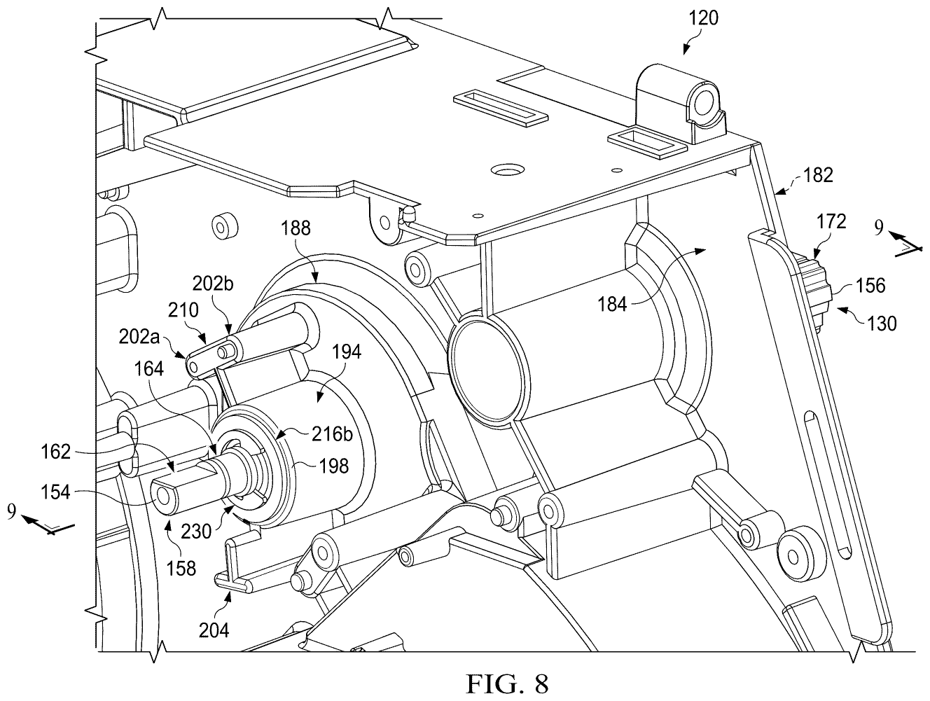

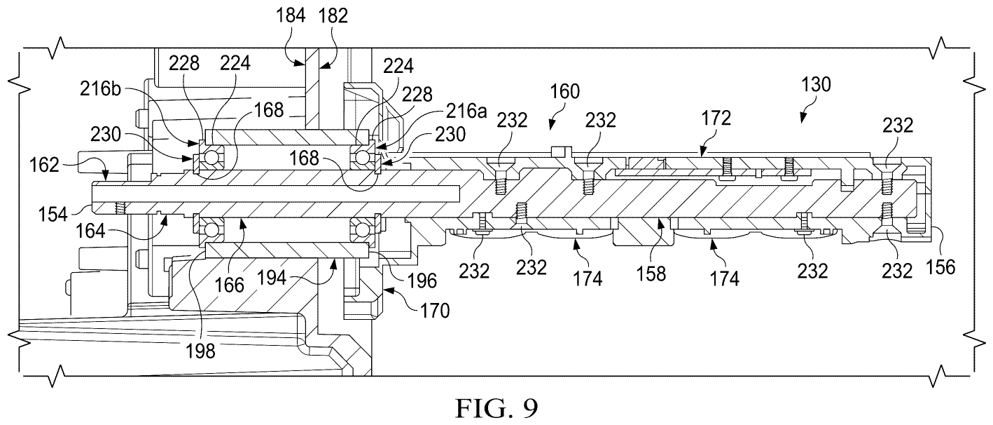

Turning to FIG. 8, the ribbon supply spindle 130 may be installed on the mounting wall 120 at the ribbon supply region 188 such that the spindle flange 170 is adjacent or proximate to the mounting wall exterior surface 182 and the shaft main body portion 166 of the shaft 158 is disposed within the spindle collar 194 (see FIG. 9). Thus, the spindle arm 172 may extend beyond the mounting wall exterior surface 182 and the shaft 158 may extend through the spindle collar 194 such that the mounting end 154 extends beyond the spindle collar second end 198. For example, the shaft notched portion 162 and the shaft midsection 164 may extend beyond the spindle collar second end 198 when the ribbon supply spindle 130 is installed on the mounting wall 120.

As best shown in the cross-sectional view of FIG. 9, the shaft 158 of the ribbon supply spindle 130 may be supported for rotation within the spindle collar 194 by a first bearing 216a adjacent to the spindle collar first end 196 and a second bearing 216b adjacent to the spindle collar second end 198. The shaft 158 may extend through the bearing opening 226 of the first and second bearings 216a, 216b, and the bearing mating surface 224 of the first and second bearings 216a, 216b may be received within the spindle collar 194 (e.g., the bearing mating surface 224 may be adjacent to or flush with an interior surface of the spindle collar 194). The bearing lip 228 of the first bearing 216a may be positioned adjacent to and/or may engage the spindle collar first end 196, and the bearing lip 228 of the second bearing 216b may be positioned adjacent to and/or may engage the spindle collar second end 198. In some instances, retaining rings 230 may be installed on grooves 168 of the shaft 158 positioned adjacent to the first bearing 216a and the second bearing 216b. Thus, the bearings 216 and the retaining rings 230 may facilitate coupling between the ribbon supply spindle 130 and the mounting wall 120 and may prevent the shaft 158 or other components of the ribbon supply spindle 130 from unintended tracking or movement with respect to the spindle collar 194 and/or the mounting wall 120 overall during use.

Additionally, as shown in FIG. 9, the hub 160 may be coupled to the shaft 158 via one or more fasteners 232 when the ribbon supply spindle 130 is assembled. For example, the fasteners 232 may extend through one or more holes (not shown) positioned along the spindle arm 172 and may be securely received by associated holes (not shown) positioned along the shaft 158 (e.g., via threaded engagement). Each of the fasteners 232 may be provided in the form of a nail, screw, pin, or any other mechanism known in the art for coupling two components together via threaded engagement, a press fit, a friction fit, or any other method. In some instances, one or more of the fasteners 232 may be provided in a different form as compared to one or more other fasteners 232.

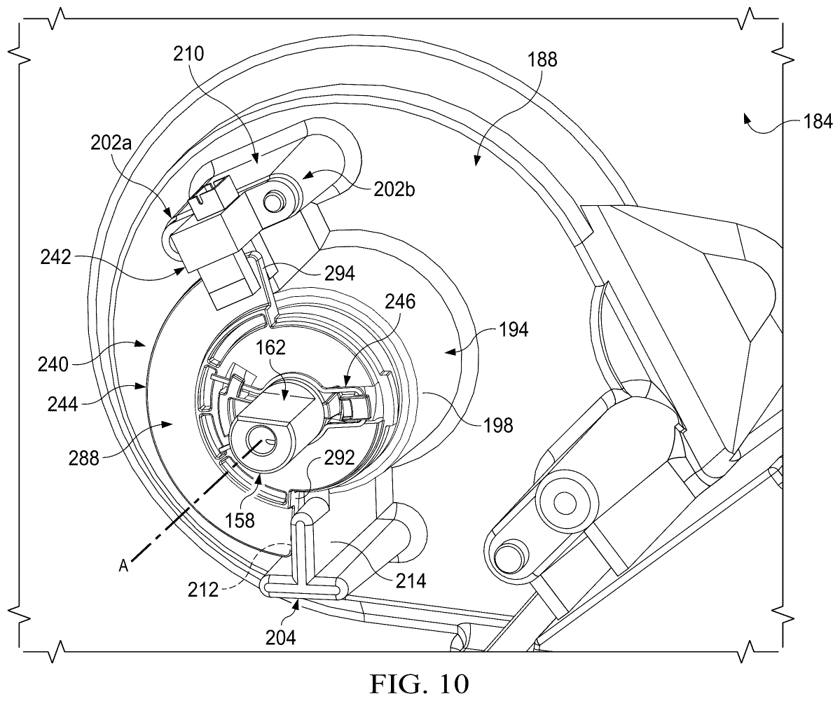

Turning now to FIG. 10, a ribbon orientation system 240 designed to detect whether the ribbon roll 136 has been installed in the correct orientation (see FIG. 3A) may include an actuator 242 connected to the mounting wall 120 and a trigger 244 connected to the shaft 158 and arranged to engage or be detected by the actuator 242. The actuator 242 may be provided in the form of a sensor, a mechanical switch, and/or other mechanisms known in the art that are capable of transmitting a variable electrical signal (e.g., a binary signal). In some instances, the ribbon orientation system 240 may include one actuator 242 connected to the mounting wall interior surface 184 via the first and second actuator mounting members 202a, 202b, and the trigger 244 may be positioned on the shaft midsection 164 (see FIG. 8). In other instances, the ribbon orientation system 240 may include more than one actuator 242, and the one or more actuators 242 and the trigger 244 may be connected to the mounting wall interior surface 184 and/or the shaft 158 in any suitable manner.

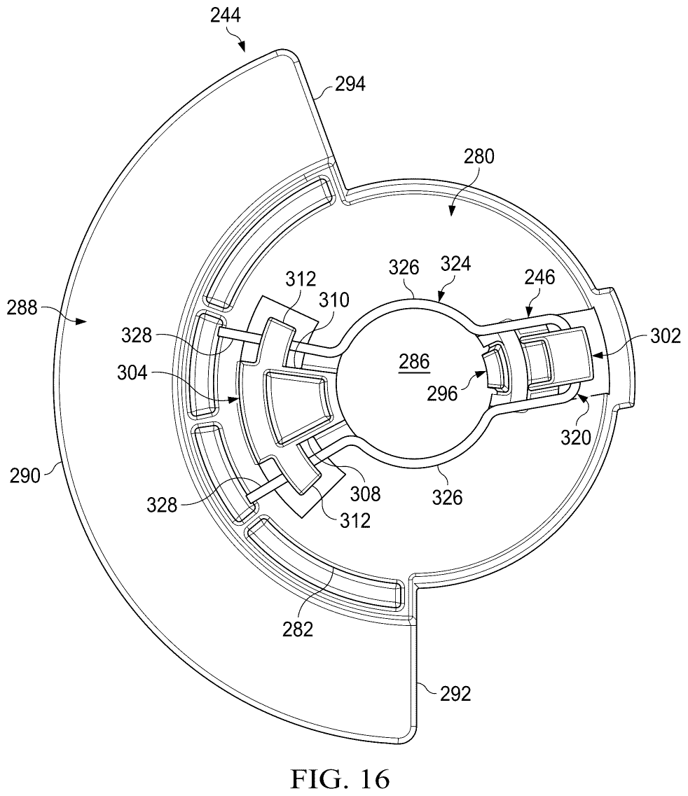

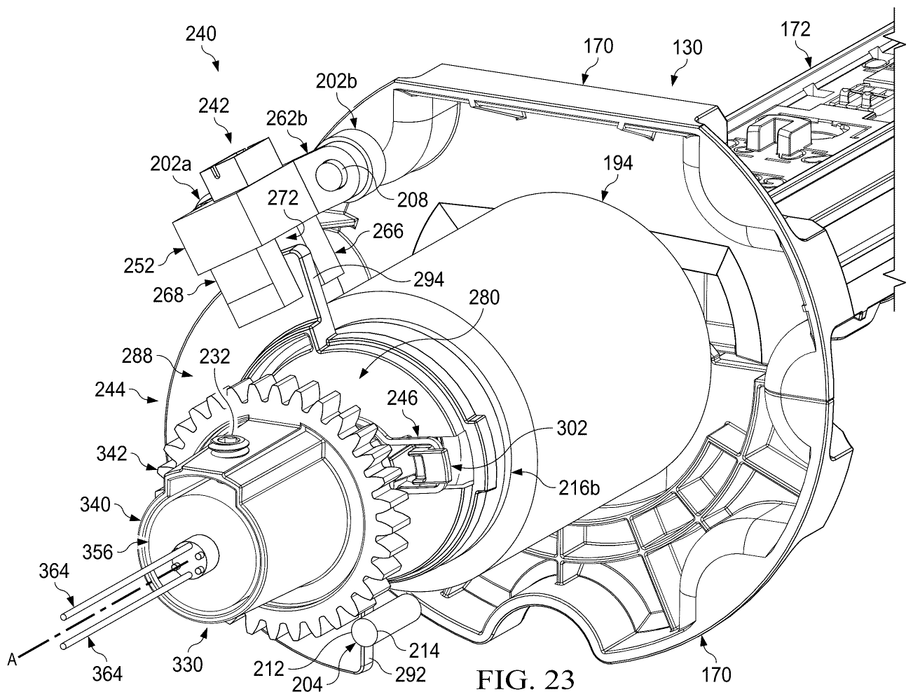

The ribbon orientation system 240 may include a connection ring 246 connected to the trigger 244 and designed to facilitate an engagement between the trigger 244 and the shaft 158 such that torque or rotational motion may be transmitted from the shaft 158 to the trigger 244, as described in detail below with reference to FIGS. 16 and 23. In some instances, the trigger 244 may be configured to engage the hardstop 204 via the first and second impact surfaces 212, 214 as it rotates about an axis of rotation A extending along the length of the shaft 158.

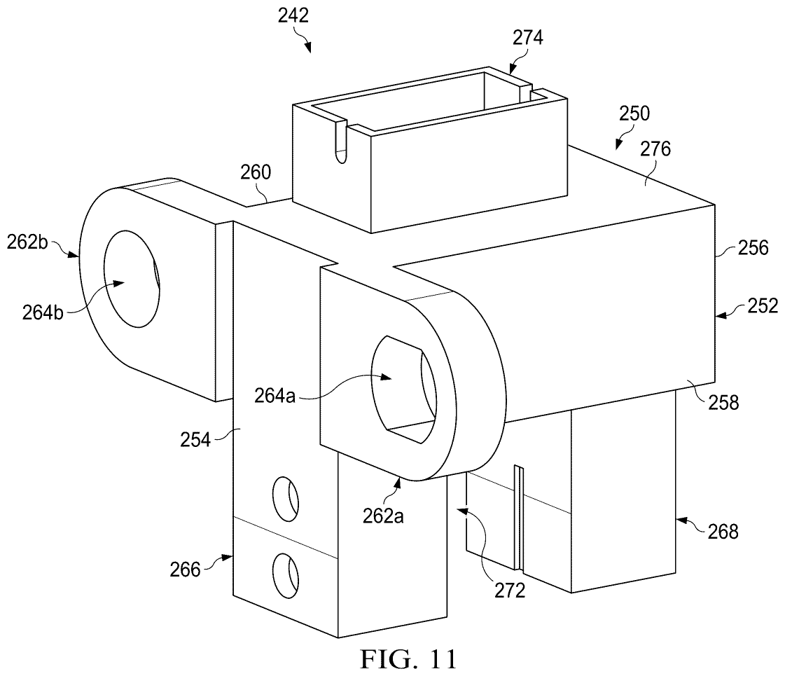

Turning to FIG. 11, in some instances, the actuator 242 may be provided in the form of an optical sensor (e.g., a photointerrupter). For example, the actuator 242 may be provided in the form of a substantially rectilinear actuator body 250 including a rectangular base member 252 defined by an actuator first end 254, an actuator second end 256 opposite the actuator first end 254, an actuator first side 258 extending between the actuator first end 254 and the actuator second end 256, and an actuator second side 260 extending between the actuator first end 254 and the actuator second end 256 and opposing the actuator first side 258. In other instances, the actuator body 250 may be imparted with a rounded shape or any other suitable shape.

The actuator 242 may include one or more wings 262 designed to facilitate attachment of the actuator 242 to the mounting wall 120. For example, the actuator 242 may include a first wing 262a and a second wing 262b arranged to align with the first actuator mounting member 202a and the second actuator mounting member 202b and facilitate coupling of the actuator 242 to the mounting wall interior surface 184. The first and second wings 262a, 262b may be formed integrally with the base member 252 or may be coupled thereto. The first wing 262a may be connected to the base member 252 proximate to the junction between the actuator first end 254 and the actuator first side 258 and extend outwardly therefrom. The second wing 262b may be connected to the base member 252 proximate to the junction between the actuator first end 254 and the actuator second side 260 and extend outwardly therefrom.

In some instances, the first wing 262a may include a first actuator connection hole 264a extending therethrough and the second wing 262b may include a second actuator connection hole 264b extending therethrough. The first actuator connection hole 264a may be provided in the form of a substantially circular, ovoid, or obround opening arranged to align with the actuator mounting hole 206 of the first actuator mounting member 202a (see FIG. 6). For example, a fastener 232 may extend through the first actuator connection hole 264a and be received within the actuator mounting hole 206 (e.g., via threaded engagement), thereby coupling the first wing 262a to the first actuator mounting member 202a (see FIG. 21). The second actuator connection hole 264b may be provided in the form of a substantially circular opening that mirrors or complements the geometry of the actuator mounting pin 208 of the second actuator mounting member 202b. The second actuator connection hole 264b may be arranged to align with and receive the actuator mounting pin 208 (e.g., in a press fit), thereby coupling the second wing 262b to the second actuator mounting member 202b (see FIG. 23).

In other instances, the first and second mounting members 202a, 202b and the first and second wings 262a, 262b may be imparted with any suitable complementary features or structure such that engagement between the actuator mounting members 202 and the wings 262 facilitates coupling of the actuator 242 to the mounting wall 120.

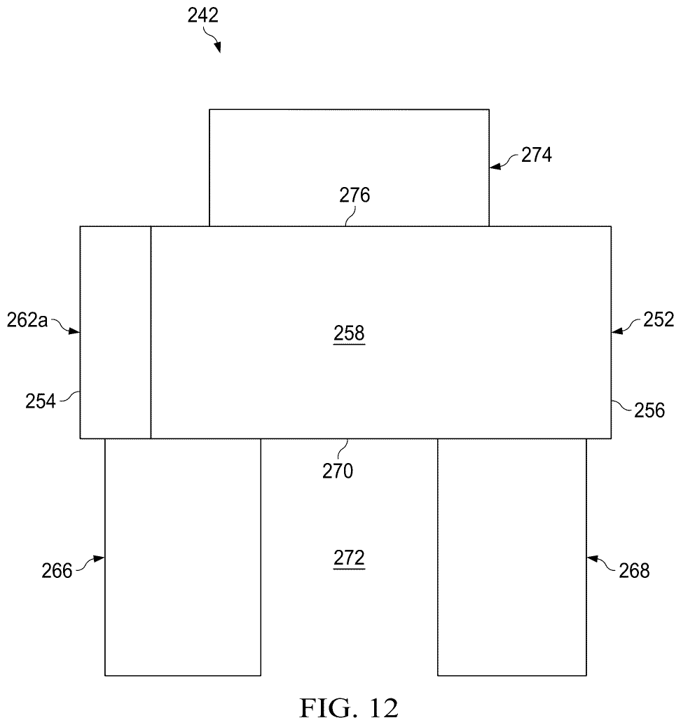

As best shown in FIG. 12, the actuator 242 may include a first leg 266 and a second leg 268 connected to a bottom side 270 of the base member 252 and extending downwardly therefrom. The first leg 266 may be provided in the form of a substantially rectangular protrusion positioned proximate to the actuator first end 254, and the second leg 268 may be provided in the form of a substantially rectangular protrusion positioned proximate to the actuator second end 256. The first and second legs 266, 268 may be substantially parallel with respect to one another such that an opening or passageway 272 is positioned between the first leg 266 and the second leg 268.

In some instances, the actuator 242 may include a port 274 provided in the form of a substantially rectilinear protrusion connected to a top side 276 of the base member 252 and extending upwardly therefrom. For example, the port 274 may be a mating portion of the actuator 242 configured to receive a connector (not shown) and facilitate a wired connection between the actuator 242 and a processor, controller, or other electronic component of a printing device (e.g., the printer 100). In other instances, the port 274 may be omitted and the actuator 242 may be configured to communicate wirelessly with the printing device (e.g., via Wi-Fi, Bluetooth, radio frequency communication, infrared communication, WLAN, and/or other wireless communication protocols known in the art). Thus, the actuator 242 may generate and transmit signals that can be received, interpreted, and/or acted upon by other components of a printing device (e.g., the printer 100).

In some instances, one of the first and second legs 266, 268 may be equipped with an emitter (not shown) configured to emit a light beam or other detectable signal across the passageway 272, and the other of the first and second legs 266, 268 may be equipped with a receiver (not shown) positioned opposite the emitter and arranged to receive the light beam or other detectable signal. Thus, the actuator 242 may be configured to occupy or detect either a first state (e.g., an unblocked state) or a second state (e.g., a blocked state) at any given moment. For example, if the light beam from the emitter can traverse the passageway 272 and reach the receiver, the actuator 242 may detect an unblocked state and generate a first signal associated with the unblocked state. If the light beam from the emitter is prevented from traversing the passageway 272 and reaching the receiver, the actuator 242 may detect a blocked state and generate a second signal associated with the blocked state.

The ribbon orientation system 240 may be configured such that one of the first and second signals generated by the actuator 242 corresponds to an acceptable operating condition (e.g., the ribbon roll 136 is installed in the correct orientation of FIG. 3A) and the other one of the first and second signals corresponds to an unacceptable operating condition (e.g., the ribbon roll 136 is installed in the incorrect orientation of FIG. 3B). Thus, a printing device (e.g., the printer 100) may be configured to interpret the signal generated by the actuator 242 and only permit printing operations to proceed if the actuator 242 detects an acceptable operating condition.

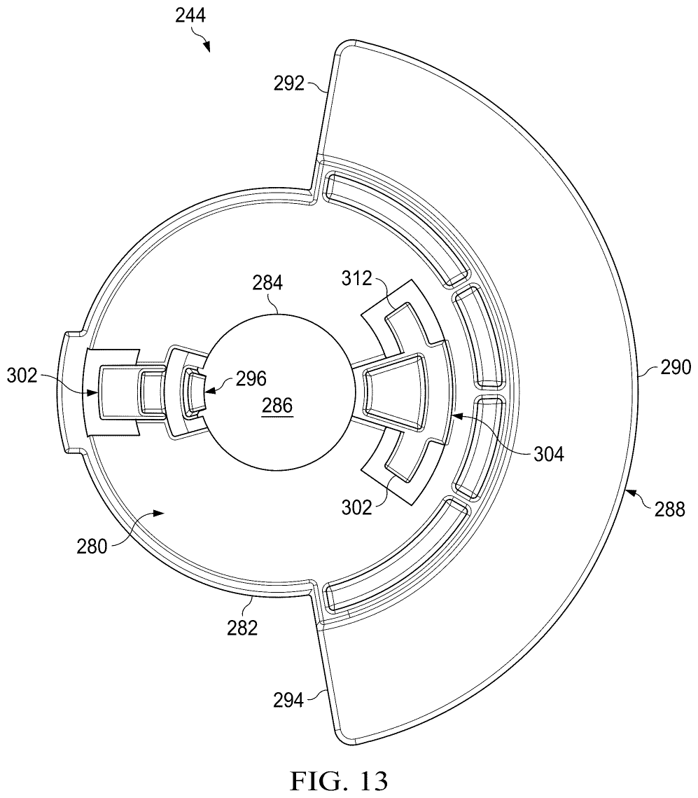

Turning to FIG. 13, the trigger 244 may be provided in the form of a substantially annular trigger core 280 defined by a trigger core exterior perimeter 282 and a trigger core interior perimeter 284. The trigger core interior perimeter 284 may define a substantially circular trigger core opening 286 extending entirely through the trigger core 280. The trigger core opening 286 may be configured to receive a portion of the ribbon supply spindle 130 (e.g., the shaft midsection 164 shown in FIG. 8).

The trigger 244 may include an interrupter 288 connected to the trigger core exterior perimeter 282 and extending outwardly therefrom. In some instances, the interrupter 288 may be provided in the form of a partial annulus (i.e., a segment of a ring-shaped structure) defined by a portion of the trigger core exterior perimeter 282 on one side and by an interrupter exterior perimeter 290 on the other side. The interrupter 288 may extend between (e.g., may be bracketed by) a first interrupter end wall 292 and a second interrupter end wall 294 opposing the first interrupter end wall 292. The first and second interrupter end walls 292, 294 may be substantially normal with respect to the trigger core exterior perimeter 282. In other instances, the interrupter 288 may be imparted with any suitable shape and/or structure provided that at least a portion of the interrupter 288 is configured to engage or be detected by the actuator 242 as the trigger 244 rotates about the axis A (see FIG. 10).

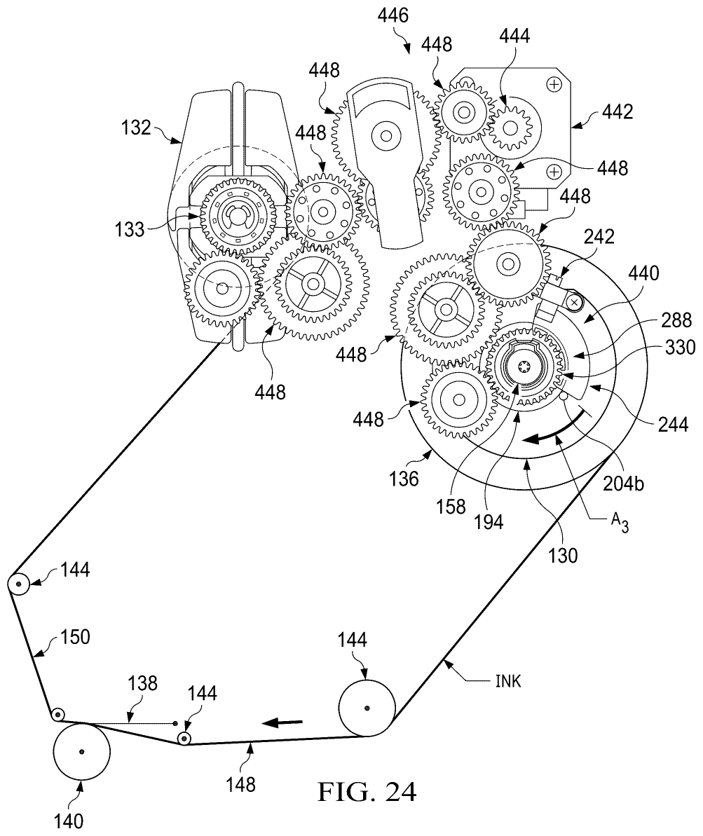

In the exemplary depiction of FIG. 13, the interrupter 288 may circumscribe a portion of the trigger core exterior perimeter 282 spanning approximately 180 degrees or slightly less than 180 degrees. In other instances, however, the interrupter 288 may circumscribe a smaller or larger portion of the trigger core exterior perimeter 282 as necessary. For example, in instances where more than one hardstop 204 is positioned on the mounting wall interior surface 184, the interrupter 288 may span a smaller portion of the trigger core exterior perimeter 282, as described in detail below with reference to FIGS. 24-27.

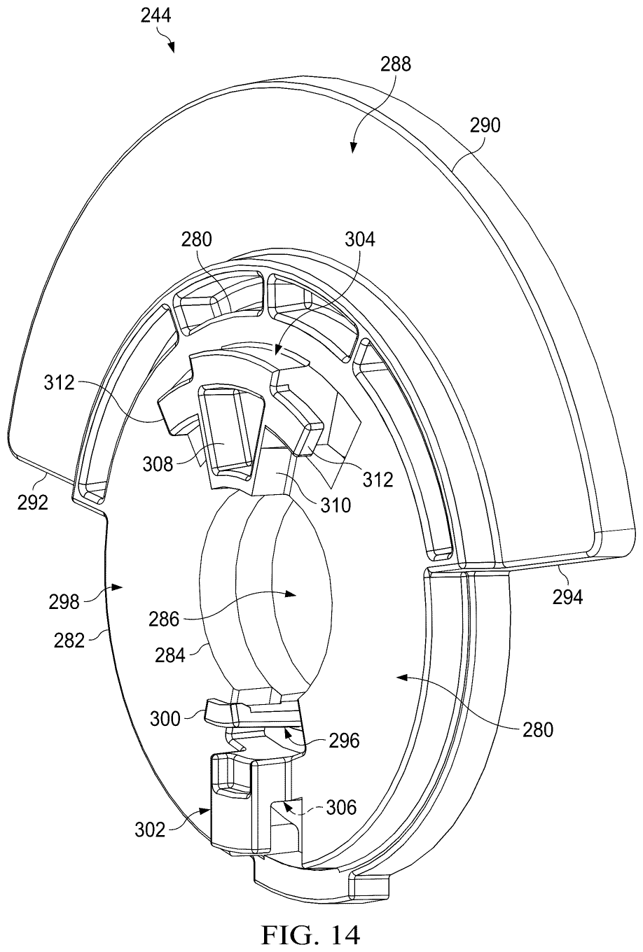

As best shown in FIG. 14, the trigger 244 may include an anchor 296 disposed about the trigger core interior perimeter 284. The anchor 296 may be connected to an attachment surface 298 of the trigger 244 and extend outwardly therefrom. The anchor 296 may include a hooked end 300 configured to help orient the trigger 244 properly when the ribbon orientation system 240 is installed by engaging an adjacent groove 168 on the shaft 158 (see FIG. 4). For example, the hooked end 300 of the anchor 296 may be retained within the groove 168 such that the trigger 244 is prevented or restricted from unintended tracking or movement along the shaft 158.

Additionally, the trigger 244 may include a first support member 302 disposed on the trigger core 280 and a second support member 304 disposed on the trigger core 280 and positioned opposite the first support member 302 with respect to the trigger core opening 286. The first and second support members 302, 304 may each be connected to the attachment surface 298 of the trigger core 280 and extend outwardly therefrom. The first and second support members 302, 304 may be configured to facilitate coupling or engagement between the trigger 244 and the connection ring 246.

For example, in some instances, the first support member 302 may be provided in the form of a substantially rectilinear, hooked protrusion defining a support surface 306. The second support member 304 may be provided in the form of a substantially rectilinear or trapezoidal protrusion defined by a first support wall 308 and a second support wall 310 positioned opposite the first support wall 308. A prong 312 may be connected to each of the first support wall 308 and the second support wall 310 and extend outwardly therefrom. In other instances, the first support member 302 and the second support member 304 may be provided in any suitable form and may be imparted with any suitable shape or structure, provided that the first and second support members 302, 304 are configured to receive, support, or engage the connection ring 246.

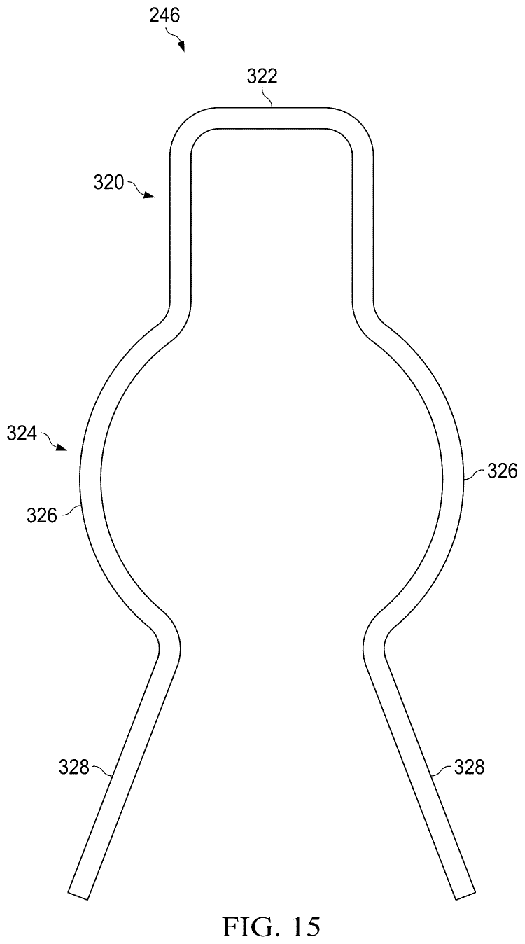

Turning now to FIG. 15, the connection ring 246 designed to transmit torque and/or rotational motion from the shaft 158 to the trigger 244 may be installed adjacent to the attachment surface 298 of the trigger core 280 via the first and second support members 302, 304. The connection ring 246 may be provided in the form of a spring clip, a pivot spring clip, or any other suitable mechanism known in the art. In some instances, the connection ring 246 may be provided in the form of a single piece of wire or other shapeable yet rigid material that can be formed or bent into a desired shape. In some instances, the connection ring 246 may include a rectangular apex region 320 including a substantially linear upper edge 322. A substantially circular connection ring midsection 324 may be provided in the form of two arc-shaped segments 326 connected to the apex region 320 and extending downwardly therefrom. A substantially linear connection ring appendage 328 may be connected to each of the arc-shaped segments 326 and extend downwardly and/or at an outward angle therefrom.

As shown in FIG. 16, the arc-shaped segments 326 may be positioned proximate to at least a portion of the trigger core opening 286 when the connection ring 246 is installed on the trigger 244, and the geometry of the arc-shaped segments 326 may mirror the geometry of the adjacent portions of the trigger core opening 286. In some instances, the arc-shaped segments 326 may be configured to contact the shaft 158 when the ribbon orientation system 240 is installed on the ribbon supply spindle 130. For example, the arc-shaped segments 326 may be imparted with substantially the same shape as the trigger core opening 286 or the arc-shaped segments 326 may be biased toward a position located inside the boundary of the trigger core opening 286. Thus, the connection ring midsection 324 may expand when the trigger core opening 286 receives the shaft 158 such that the arc-shaped segments 326 contact the shaft 158 and apply a reciprocal inward force thereto. In this way, the connection ring 246 may engage the shaft 158 by generating friction as the trigger 244 rotates about the axis A (see FIG. 10).

The connection ring 246 may be installed on the trigger 244 such that the apex region 320 is received by the first support member 302 and positioned proximate to the support surface 306 (see FIG. 14). The connection ring appendages 328 may be positioned adjacent to the first and second support walls 308, 310 of the second support member 304. Thus, the first support member 302 and the prongs 312 of the second support member 304 may prevent or restrict the connection ring 246 from unintentional tracking or movement along the shaft 158 (e.g., away from the trigger 244) during use. The connection ring 246 may also engage the trigger 244 by, for example, impacting the first support member 302 and/or the second support member 304 such that the connection ring 246 can transmit torque and/or rotational motion from the shaft 158 to the trigger 244 (see, e.g., FIG. 10).

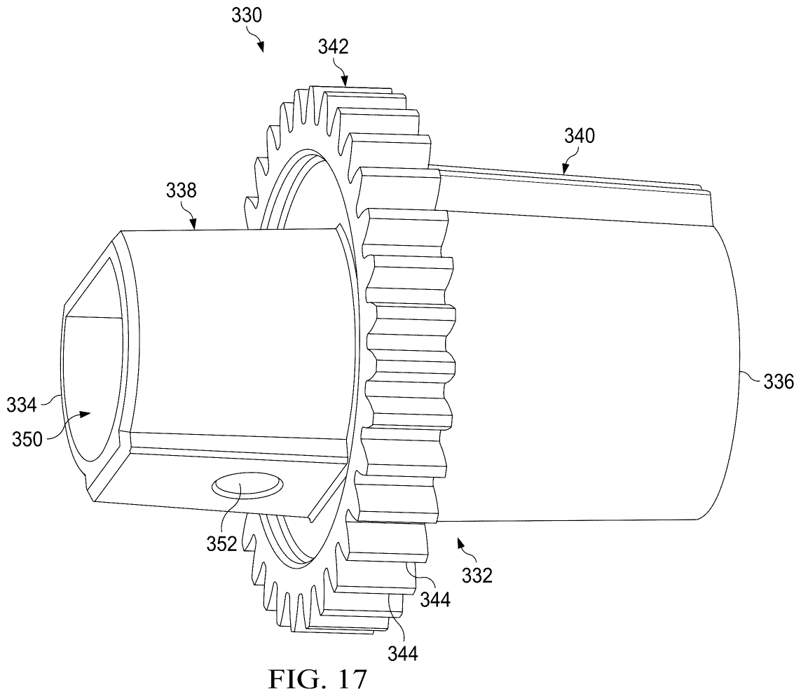

Turning to FIG. 17, a gear unit 330 designed to facilitate engagement and/or communication between the ribbon supply spindle 130 and a printing device (e.g., the printer 100) may be provided in the form of a substantially annular gear unit body 332 defined by a gear unit first end 334 and a gear unit second end 336 opposing the gear unit first end 334. The gear unit 330 may include a shaft connection region 338 at the gear unit first end 334, a slip ring housing 340 at the gear unit second end 336, and a gear member 342 positioned between the shaft connection region 338 and the slip ring housing 340. The gear member 342 may include a plurality of teeth 344 circumscribing the gear member 342 and configured, for example, to be engaged by an associated geared component (not shown) of a printing device (e.g., the printer 100) designed to generate rotation of the ribbon supply spindle 130 during printing operations.

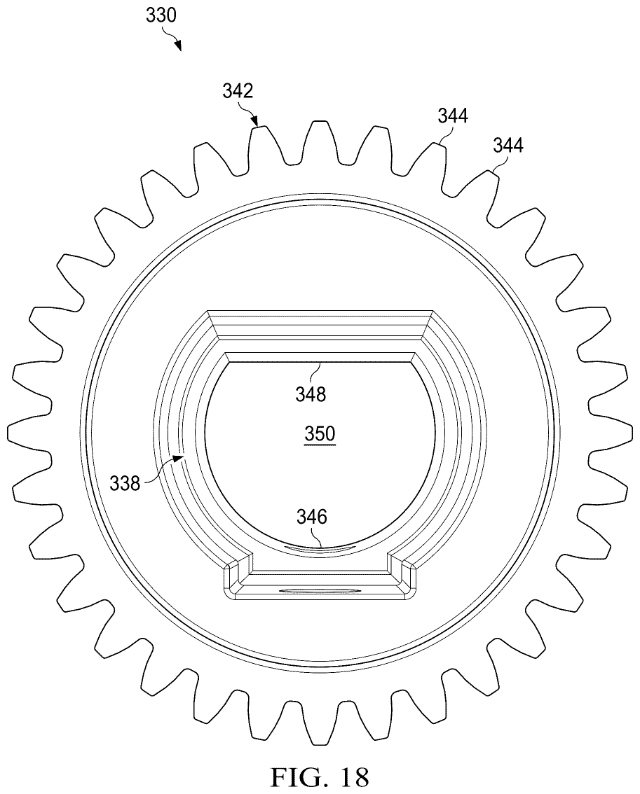

As best shown in FIG. 18, the shaft connection region 338 may be imparted with a structure that mirrors or complements the structure of the shaft notched portion 162 (see, e.g., FIG. 8). For example, the shaft connection region 338 may be imparted with the shape of a partial cylinder and may include a substantially semicircular lower edge 346 and a substantially flat upper edge 348. Thus, the shaft connection region 338 may define a gear unit shaft opening 350 extending entirely therethrough and configured to receive the shaft notched portion 162. In some instances, the shaft connection region 338 may include a first gear unit hole 352 (see FIG. 17) arranged to align with an associated opening (not shown) in the shaft notched portion 162 such that a fastener 232 may extend through the first gear unit hole 352 and be received by the associated opening in the shaft notched portion 162, thereby coupling the gear unit 330 to the shaft 158 (see FIGS. 21 and 22). Thus, the shaft connection region 338 may be configured to prevent or inhibit rotation of the gear unit 330 with respect to the shaft 158 during use (e.g., due to engagement between the upper edge 348 and an adjacent surface of the shaft notched portion 162). In other instances, the shaft connection region 338 and gear unit shaft opening 350 may be imparted with any suitable shape or structure, provided that the shaft connection region 338 is designed to securely receive the mounting end 154 of the ribbon supply spindle 130 (see FIG. 4).

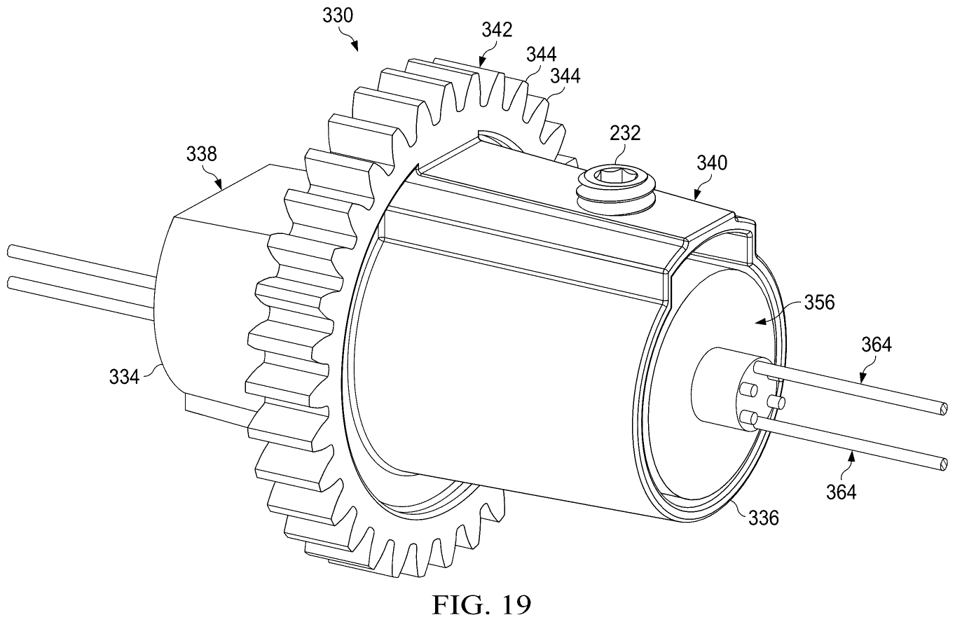

Turning to FIG. 19, the slip ring housing 340 may be provided in the form of a substantially cylindrical receptacle extending between the gear member 342 and the gear unit second end 336. In some instances, the slip ring housing 340 may be configured to retain a slip ring 356. For example, a fastener 232 may extend through a hole (not shown) in the slip ring housing 340 and be received by an associated hole (not shown) in the slip ring 356 such that the slip ring 356 may be coupled to the gear unit 330 (see FIGS. 21-23).

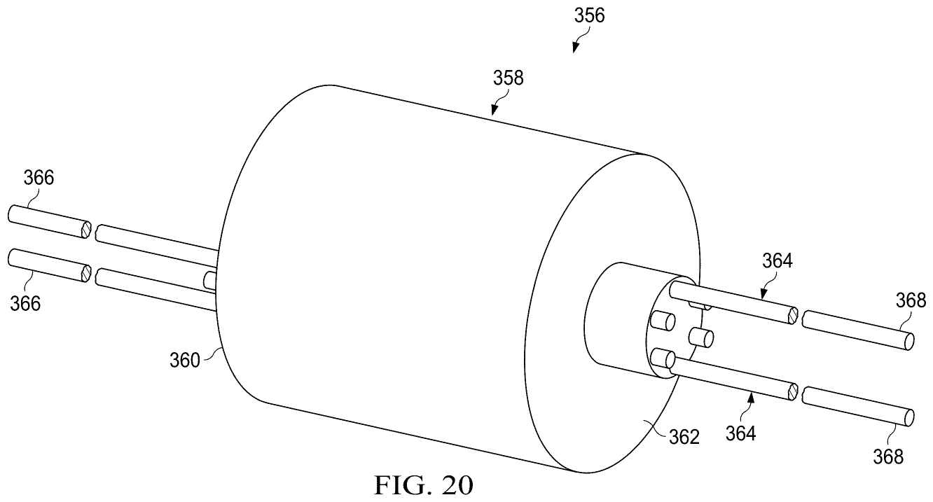

As shown in FIG. 20, the slip ring 356 may be provided in the form of a substantially cylindrical slip ring body 358 defined by a slip ring first end 360 and a slip ring second end 362 opposing the slip ring first end 360. The slip ring body 358 may include internal components (not shown) such as conductive rings, brushes, contacts, bearings, insulating material, and the like disposed within an internal enclosure defined by the slip ring body 358. One or more wires 364 may extend through the slip ring body 358. For example, each of the wires 364 may include an output end 366 extending beyond the slip ring first end 360 and an input end 368 extending beyond the slip ring second end 362. Thus, the slip ring 356 may be configured to facilitate an electrical connection and/or communication between rotating and stationary components of a printing device. For example, in the context of the printer 100, the slip ring 356 may facilitate an electrical connection and/or communication between one or more components configured to rotate with the ribbon supply spindle 130 about the axis A (see FIG. 10) and one or more stationary components (e.g., a processor or controller) of the printer 100. In other instances, the slip ring 356 may facilitate an electrical connection and/or communication between any two components of the printer 100 (e.g., two stationary components or two rotating components).

Turning to FIG. 21, the ribbon orientation system 240 may be installed on the portion of the shaft 158 that extends beyond the spindle collar second end 198 and is not encased within the hub 160 or the spindle collar 194. FIG. 21 depicts the ribbon orientation system 240, the gear unit 330, and the slip ring 356 installed on the ribbon supply spindle 130. The spindle collar 194, first actuator mounting member 202a, second actuator mounting member 202b, and hardstop 204 are shown in FIG. 21, but the remainder of the mounting wall 120 is omitted for clarity. As shown, the trigger 244 may be configured such that a portion of the trigger 244 is arranged for engagement with the hardstop 204 and at least a portion of the trigger 244 is arranged to engage or be detected by the actuator 242 (e.g., a portion of the trigger 244 may be disposed between the first and second legs 266, 268 of the actuator 242 depending on the rotational position of the trigger 244).

The gear unit 330 may be coupled to the shaft 158 and positioned opposite the spindle collar 194 with respect to the actuator 242 and the trigger 244. The gear member 342 may be available for engagement with an associated geared component of a printing device (e.g., the printer 100) such that the printing device may drive rotation of the ribbon supply spindle 130 by engaging the gear unit 330 via the gear member 342. The slip ring 356 may be retained within the slip ring housing 340 (e.g., the slip ring 356 may be positioned within the slip ring housing 340 and coupled thereto by a fastener 232). Thus, the slip ring 356 may be configured to facilitate the transmission of electrical signals between components of the ribbon supply spindle 130 or the ribbon orientation system 240 (e.g., the actuator 242) and an external device (e.g., a processor or controller of the printer 100). In some instances, the slip ring 356 may also be connected to an external power source (not shown) such that the slip ring 356 may provide power to one or more components of the ribbon supply spindle 130 or the ribbon orientation system 240.

As best shown in FIG. 22, in some instances, the shaft main body portion 166 may be retained within the spindle collar 194 by the first and second bearings 216a, 216b and the retaining rings 230. The trigger 244 may be positioned on the shaft midsection 164. The gear unit 330 may be coupled to the shaft notched portion 162. In other instances, the ribbon supply spindle 130 may be installed on the mounting wall 120 in any suitable manner, and the ribbon orientation system 240, gear unit 330, and slip ring 356 may be connected to the shaft 158 in any suitable manner.

Turning to FIG. 23, in some instances, the hardstop 204 may be provided in the form of a substantially cylindrical protrusion that serves the same purpose as the T-shaped hardstop 204 depicted in FIG. 10. For example, the T-shaped hardstop 204 shown in FIG. 10 includes the first impact surface 212 and the second impact surface 214 positioned to be engaged by the first interrupter end wall 292 and the second interrupter end wall 294 of the interrupter 288, respectively, depending on the rotational position of the trigger 244 about the axis A. In some instances, the first interrupter end wall 292 may engage the first impact surface 212 when the ribbon supply spindle 130 rotates in a first direction (e.g., the direction of the arrow A₁ shown in FIG. 3A), and the second interrupter end wall 294 may engage the second impact surface 214 when the ribbon supply spindle 130 rotates in a second direction (e.g., the direction of the arrow A₂ shown in FIG. 3B).

Similarly, the cylindrical hardstop 204 of FIG. 23 may include a first impact surface 212 positioned on a first side of the hardstop 204 and a second impact surface 214 positioned in an opposite location with respect to the first impact surface 212. Thus, the first interrupter end wall 292 may engage the first impact surface 212 when the ribbon supply spindle 130 rotates in the first direction (e.g., the direction of the arrow A₁ shown in FIG. 3A), and the second interrupter end wall 294 may engage the second impact surface 214 when the ribbon supply spindle 130 rotates in the second direction (e.g., the direction of the arrow A₂ shown in FIG. 3B).

The trigger 244 may be configured such that a portion of the trigger 244 (e.g., the interrupter 288) is positioned within the passageway 272 of the actuator 242 when the ribbon supply spindle 130 rotates in the first direction and the first interrupter end wall 292 engages the first impact surface 212 of the hardstop 204. The first direction may correspond to the direction of rotation of the ribbon supply spindle 130 when the ribbon roll 136 is installed with the correct orientation (see FIG. 3A). On the other hand, no portion of the trigger 244 may be positioned within the passageway 272 of the actuator 242 when the ribbon supply spindle 130 rotates in the second direction and the second interrupter end wall 294 engages the second impact surface 214 of the hardstop 204. The second direction may correspond to the direction of rotation of the ribbon supply spindle 130 when the ribbon roll is installed with the incorrect orientation (see FIG. 3B).

Therefore, in some instances, the ribbon orientation system 240 may be configured such that the actuator 242 occupies or detects the blocked state when the ribbon roll 136 is installed with the correct orientation. The actuator 242 may occupy or detect the unblocked state when the ribbon roll 136 is installed with the incorrect orientation. In these instances, a processor or controller of a printing device (e.g., the printer 100) may be configured to proceed with printing operations when the actuator 242 indicates that it occupies or detects the blocked state and the printing device determines that the ribbon supply spindle 130 is in an acceptable operating condition. However, the processor or controller may be configured to take corrective action (e.g., by preventing printing operations or by displaying an error message) when the actuator 242 indicates that it occupies or detects the unblocked state and the printing device determines that the ribbon supply spindle 130 is in an unacceptable operating condition. In other instances, a reverse configuration is possible where the blocked state of the actuator 242 corresponds to an unacceptable operating condition and the unblocked state of the actuator 242 corresponds to an acceptable operating condition.

As explained above with reference to FIG. 16, the connection ring 246 may transmit torque and/or rotational motion from the ribbon supply spindle 130 to the trigger 244, for example, by generating friction via contact between the arc-shaped segments 326 and the shaft 158. For example, the shaft 158 may extend through the trigger core opening 286 such that the shaft 158 is permitted to rotate relative to the trigger 244. However, in the absence of an opposing force, the friction generated by the connection ring 246 may cause the connection ring 246 to rotate with the shaft 158 as the ribbon supply spindle 130 rotates (e.g., as ribbon material is unwound from the ribbon supply spindle 130 as shown in FIG. 3A). Thus, the connection ring 246 may transmit at least a portion of the rotational motion of the shaft 158 to the trigger 244 via engagement between the apex region 320 and the first support member 302 and between the connection ring appendages 328 and the second support member 304 (see FIG. 16).

In this way, the rotation of the ribbon supply spindle 130 in the first direction as indicated by the arrow A₁ (see FIG. 3A) may cause the trigger 244 to rotate along with the ribbon supply spindle 130 until the first interrupter end wall 292 contacts or engages the hardstop 204 (e.g., via the first impact surface 212). The hardstop 204 may thus terminate the rotation of the trigger 244 in response to rotation of the ribbon supply spindle 130 by opposing the force applied by the friction generated by the connection ring 246. Overrunning of the trigger 244 may permit the shaft 158 to continue rotating freely with respect to the trigger 244 while the first interrupter end wall 292 engages the hardstop 204. In some instances, the connection ring 246 may be designed to generate an amount of friction that is easily overcome by the engagement between the interrupter 288 and the hardstop 204. Therefore, to the extent the connection ring 246 continues to contact the shaft 158 and generate friction while the trigger 244 is overrunning, the friction may not be strong enough to cause damage or otherwise interfere with printing operations (e.g., by generating heat sufficient to damage the shaft 158, the trigger 244, or any other component of the ribbon supply spindle 130 or the ribbon orientation system 240).

Referring still to FIG. 23, the ribbon orientation system 240 is depicted in a position where the trigger 244 overruns as the ribbon supply spindle 130 rotates in the first direction, as indicated by the arrow A₁ in FIG. 3A. The trigger 244 may be constructed such that the second interrupter end wall 294 extends through the passageway 272 when the interrupter 288 engages the hardstop 204 via the first interrupter end wall 292. Thus, a portion of the interrupter 288 may be disposed between the first and second legs 266, 268 of the actuator 242, and the actuator 242 may occupy or detect the blocked position while the trigger 244 slips or overruns. Thus, the actuator 242 may generate the first signal indicating that the ribbon roll 136 is installed correctly in the first orientation. Accordingly, the printing device (e.g., the printer 100) may proceed with printing operations in response to detecting or receiving the first signal from the actuator 242.

By contrast, if the ribbon supply spindle 130 rotates in the second direction as indicated by the arrow A₂ (see FIG. 3B) because the ribbon roll 136 was installed incorrectly in the second orientation, the friction generated by the connection ring 246 may cause the trigger 244 to rotate with the ribbon supply spindle 130 until the second interrupter end wall 294 contacts or engages the hardstop 204 (e.g., via the second impact surface 214). The trigger 244 may be constructed such that the first interrupter end wall 292 does not extend through the passageway 272 when the interrupter 288 engages the hardstop 204 via the second interrupter end wall 294. Thus, no portion of the interrupter 288 may be disposed between the first and second legs 266, 268 of the actuator 242, and the actuator 242 may occupy or detect the unblocked position while the trigger 244 slips or overruns. Thus, the actuator 242 may generate the second signal indicating that the ribbon roll 136 is installed incorrectly in the second orientation. Accordingly, the printing device (e.g., the printer 100) may disallow printing operations and/or take one or more other corrective actions such as presenting an error message to a user (e.g., via the user interface 110 shown in FIG. 1) in response to detecting or receiving the second signal from the actuator 242.

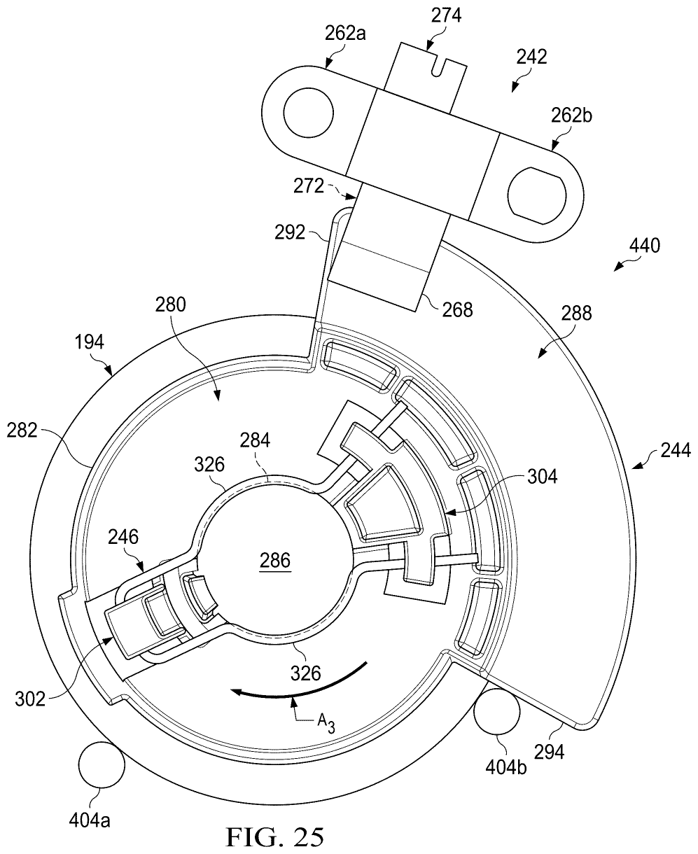

Turning to FIGS. 24-27, another example of a ribbon orientation system 440 for use with a printing device (e.g., the printer 100) is depicted according to the principles of the present disclosure. The ribbon orientation system 440 may be identical to the ribbon orientation system 240 with the exceptions that (i) the mounting wall 120 may include a first hardstop 204a and a second hardstop 204b instead of a single hardstop 204 (compare FIG. 6 with FIG. 25), and (ii) the ribbon orientation system 440 may include a trigger 244 with an interrupter 288 that is smaller, or spans a smaller portion of the trigger core exterior perimeter 282, than the interrupter 288 of the ribbon orientation system 240 (see FIG. 13). Other than these exceptions, the same names and reference numerals will be used to refer to components of the ribbon orientation system 440 that are similar in form and function to the corresponding components of the ribbon orientation system 240.

Turning first to FIG. 24, a ribbon roll 136 may be correctly installed on the ribbon supply spindle 130 in a third orientation (the third orientation shown in FIG. 24 may correspond to the first orientation shown in FIG. 3A). When the ribbon roll 136 is installed correctly in the third orientation, the ribbon supply spindle 130 may rotate in a third direction as indicated by the arrow A₃ as printing operations are performed. The ribbon material 134 may be guided by one or more rollers 144 and/or one or more diverters 146 (not shown) along a ribbon path from the ribbon supply spindle 130 to the waste ribbon spindle 132 where the ribbon material 134 may be spooled and collected after the ribbon material 134 is used. The ribbon material 134 may be guided between the printhead 138 and the platen roller 140, where the ribbon material 134 may contact and transfer ink to the printable media 128 (not shown) as described above with reference to FIG. 2.

As shown in FIG. 24, the printing device (e.g., the printer 100) may include a driver 442, a pinion gear 444 connected to the driver 442, and a gear train 446 in communication with the pinion gear 444 and including one or more gears 448. The gear train 446 may facilitate communication between the pinion gear 444 and the gear unit 330 connected to the ribbon supply spindle 130 and/or the waste ribbon spindle gear member 133 (see FIG. 2). In some instances, the driver 442 may be provided in the form of a motor or other electrical device configured to generate rotational movement of the pinion gear 444. The pinion gear 444 may engage one or more gears 448 of the gear train 446 and transmit the rotational motion generated by the driver 442 thereto. The gears 448 may be connected in sequence such that the rotational motion of the pinion gear 444 may be transmitted to the gear unit 330 and/or the waste ribbon spindle gear member 133 via the gear train 446.

Thus, in some instances, rotation of the gear unit 330 and the waste ribbon spindle gear member 133 may be generated simultaneously as unused ribbon material 134 is unwound from the ribbon supply spindle 130 and used ribbon material 134 is wound about the waste ribbon spindle 132 while printing operations are performed. In other instances, the printing device (e.g., the printer 100) may generate rotation of the gear unit 330 and/or the waste ribbon spindle gear member 133 via any other suitable method known in the art. In this context, the gear unit 330 may serve the role of the ribbon supply spindle gear member 131 as described above with reference to FIG. 2. In some instances, the printing device may generate rotational motion of the gear unit 330 alone or of the waste ribbon spindle gear member 133 alone.

Turning to FIG. 25, rotation of the ribbon supply spindle 130 in the direction of the arrow A₃ may cause the trigger 244 to rotate in response thereto due to engagement (e.g., friction) between the connection ring 246 and the shaft 158 of the ribbon supply spindle 130 as described in detail above with reference to FIGS. 16 and 23. Thus, when the ribbon roll 136 is correctly installed in the third orientation, the trigger 244 may rotate in the direction of the arrow A₃ until the second interrupter end wall 294 impacts or engages the second hardstop 204b. The second hardstop 204b may prevent the trigger 244 from rotating any further in the third direction of the arrow A₃ (e.g., the second hardstop 204b may oppose the force applied to the trigger 244 by the friction generated by the connection ring 246). For example, the trigger 244 may overrun and remain in a fixed position as the shaft 158 continues to rotate freely within the trigger core opening 286.

As shown in FIG. 25, the trigger 244 of the ribbon orientation system 440 may be constructed such that the first interrupter end wall 292 extends through the passageway 272 of the actuator 242 when the interrupter 288 engages the second hardstop 204b via the second interrupter end wall 294. Thus, a portion of the interrupter 288 may be disposed between the first and second legs 266, 268 of the actuator 242 and the actuator 242 may occupy or detect the blocked position while the trigger 244 slips or overruns. In response, the actuator 242 may generate the first signal indicating that an acceptable operating condition is detected and the printing device (e.g., the printer 100) may proceed with printing operations.

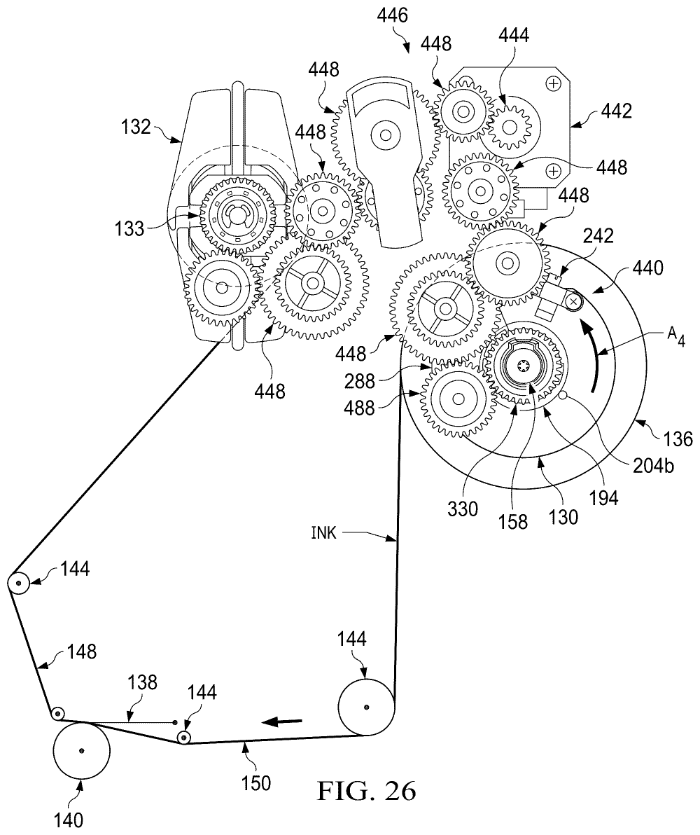

Turning to FIG. 26, the ribbon roll 136 may be incorrectly installed on the ribbon supply spindle 130 in a fourth orientation (the fourth orientation shown in FIG. 26 may correspond to the second orientation shown in FIG. 3B). The driver 442, pinion gear 444, and gear train 446 may drive rotation of the ribbon supply spindle 130 and/or the waste ribbon spindle 132, and the ribbon material 134 may be guided along a ribbon path between the ribbon supply spindle 130 and the waste ribbon spindle 132 as described above with reference with reference to FIG. 24. When the ribbon roll 136 is incorrectly installed in the fourth orientation, the ribbon supply spindle 130 may rotate in the direction indicated by the arrow A₄ (e.g., opposite the direction of the arrow A₃).

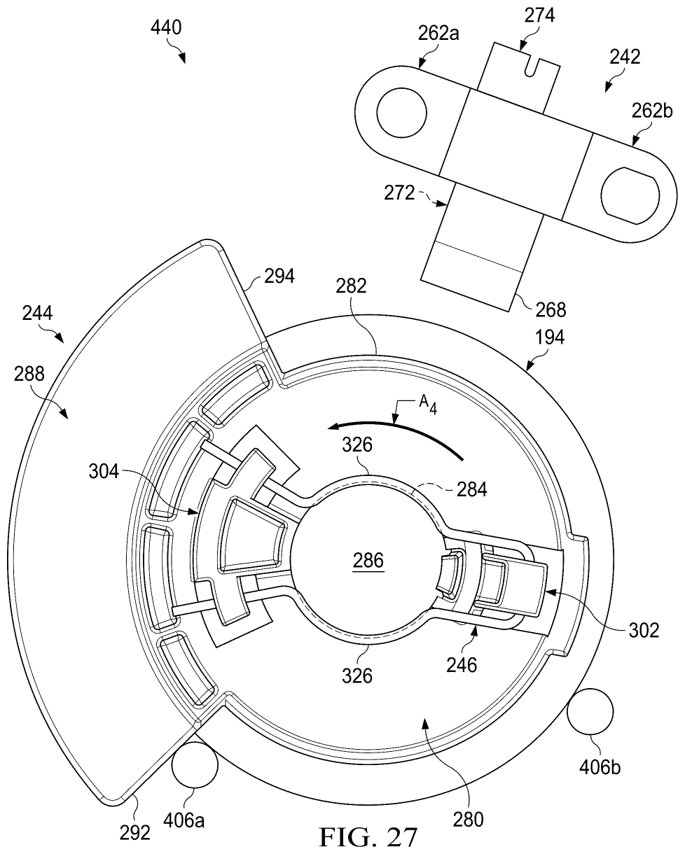

Turning to FIG. 27, rotation of the ribbon supply spindle 130 in the direction of the arrow A₄ may cause the trigger 244 to rotate in response thereto due to engagement (e.g., friction) between the connection ring 246 and the shaft 158 of the ribbon supply spindle 130 as described in detail above with reference to FIGS. 16 and 23. Thus, when the ribbon roll 136 is incorrectly installed in the fourth orientation, the trigger 244 may rotate in the direction of the arrow A₄ until the first interrupter end wall 292 impacts or engages the first hardstop 204a. The first hardstop 204a may prevent the flag 410 from rotating any further in the direction of the arrow A₄ (e.g., the first hardstop 204a may oppose the force applied to the trigger 244 by the friction generated by the connection ring 246). For example, the trigger 244 may overrun and remain in a fixed position as the shaft 158 continues to rotate freely within the trigger core opening 286.

As shown in FIG. 27, the trigger 244 of the ribbon orientation system 440 may be constructed such that the second interrupter end wall 294 extends through the passageway 272 of the actuator 242 when the interrupter 288 engages the first hardstop 204a via the first interrupter end wall 292. Thus, a portion of the interrupter 288 may be disposed between the first and second legs 266, 268 of the actuator 242 and the actuator 242 may occupy or detect the unblocked position while the trigger 244 slips or overruns with respect to the ribbon supply spindle 130. In response, the actuator may generate the second signal indicating that an unacceptable operating condition is detected and corrective action may be taken rather than permitting printing operations to proceed. For example, the printing device (e.g., the printer 100) may disallow printing operations and/or take one or more other corrective actions such as presenting an error message to a user (e.g., via the user interface 110 shown in FIG. 1).

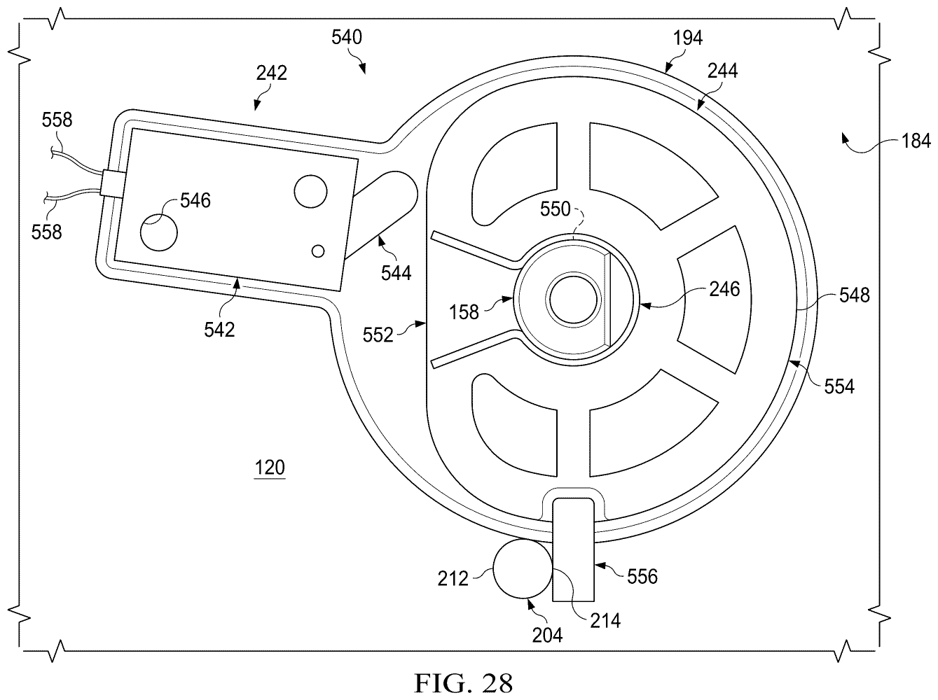

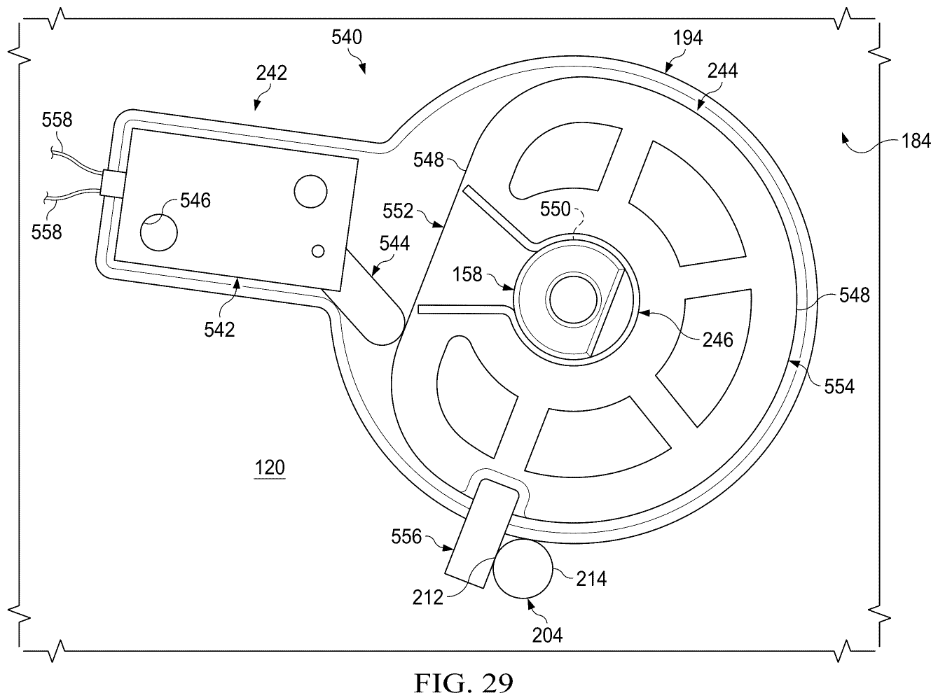

Turning now to FIGS. 28 and 29, a further example of a ribbon orientation system 540 is depicted according to the principles of the present disclosure. The ribbon orientation system 540 may function similarly with respect to the ribbon orientation system 240 and the ribbon orientation system 440, as described above. However, in the case of the ribbon orientation system 540, the actuator 242 may be provided in the form of a mechanical switch rather than a sensor as in the ribbon orientation systems 240, 440, and the trigger 244 may be imparted with a different shape and/or structure as compared to the trigger 244 of the ribbon orientation systems 240, 440.

As shown in FIG. 28, the actuator 242 of the ribbon orientation system 540 may be provided in the form of a switch body 542 and a switch lever 544 connected to the switch body 542 and extending outwardly therefrom. The switch body 542 may include one or more switch holes 546 provided in the form of substantially circular openings extending entirely through the switch body 542, for example, to facilitate coupling between the actuator 242 and the one or more actuator mounting members 202 on the mounting wall interior surface 184 (see FIG. 6). Thus, the switch body 542 may have a fixed position, and the switch lever 544 may protrude outwardly therefrom such that the switch lever 544 is available for engagement with the trigger 244. For example, the switch lever 544 may be movable between a first position (see FIG. 28) and a second position (see FIG. 29).

The trigger 244 of the ribbon orientation system 540 may be provided in the form of a cammed disc defined by a trigger exterior perimeter 548 and a trigger interior perimeter 550. The trigger interior perimeter 550 may define a substantially circular trigger opening (not shown) designed to receive a portion of the ribbon supply spindle 130 (e.g., the shaft 158) when the ribbon orientation system 540 is installed. In some instances, the trigger exterior perimeter 548 may include a substantially flat idle edge 552 and a substantially semicircular active edge 554. The idle edge 552 may be configured to pass by the switch lever 544 (e.g., the idle edge 552 may not engage the switch lever 544) as the trigger 244 rotates about the axis A (see FIG. 23). In some instances, the active edge 554 may be configured to engage the switch lever 544 depending on the rotational position of the trigger 244. In other instances, the idle edge 552 and the active edge 554 may each be configured to avoid engagement with the actuator 242 as the trigger 244 rotates. The connection ring 246 may facilitate engagement between the shaft 158 and the trigger 244 (e.g., by generating friction as the trigger 244 rotates) as described in detail above with reference to FIGS. 16 and 23.

In some instances, the trigger 244 may include an impact member 556 connected to the trigger 244 and extending outwardly therefrom. For example, the impact member 556 may be provided in the form of a rectangular protrusion including a portion thereof extending beyond the trigger exterior perimeter 548. In other instances, the impact member 556 may be provided in any suitable form and may be formed integrally with the trigger 244 or may be coupled thereto. The ribbon orientation system 540 may include one or more hardstops 204 arranged for engagement with the impact member 556. For example, in some instances, the ribbon orientation system 540 may include a single hardstop 204 including a first impact surface 212 and a second impact surface 214 such that the impact member 556 may contact the first impact surface 212 or the second impact surface 214 depending on the rotational position of the trigger 244. The hardstop 204 is depicted as a substantially cylindrical protrusion in FIG. 28, however the hardstop 204 may be provided in any suitable form (e.g., the ribbon orientation system 540 may include one or more T-shaped hardstops 204 as shown in FIG. 6).

The trigger 244 of the ribbon orientation system 540 may be configured to engage the hardstop 204 via the impact member 556 in substantially the same manner as the trigger 244 of the ribbon orientation system 240 is configured to engage the hardstop 204 via the first and second interrupter end walls 292, 294, as explained above with reference to FIG. 23. For example, in some instances, the switch lever 544 may occupy the first position as a default position, as shown in FIG. 28. When the ribbon supply spindle 130 rotates in a first direction (e.g., as indicated by the second arrow A₂ of FIG. 3B), the connection ring 246 may cause the trigger 244 to rotate with the shaft 158 until the impact member 556 engages the hardstop 204 via the second impact surface 214. The idle edge 552 of the trigger exterior perimeter 548 may be adjacent to the switch lever 544 when the impact member 556 engages the second impact surface 214. Thus, the trigger 244 may not engage the switch lever 544 and the switch lever 544 may occupy the first position shown in FIG. 28.

Turning to FIG. 29, in some instances, rotation of the ribbon supply spindle 130 in a second direction may cause the trigger 244 to move the switch lever 544 from the first position to the second position. For example, when the ribbon supply spindle 130 rotates in the second direction (e.g., as indicated by the first arrow A₁ of FIG. 3A), the connection ring 246 may cause the trigger to rotate with the shaft 158 until the impact member 556 engages the hardstop 204 via the first impact surface 212. The active edge 554 of the trigger exterior perimeter 548 may be adjacent to the switch lever 544 when the impact member 556 engages the first impact surface 212. Thus, the trigger 244 may engage the switch lever 544 as the impact member 556 rotates toward the first impact surface 212 such that the switch lever 544 moves from the first position to the second position. In some instances, sustained contact between the active edge 554 and the switch lever 544 may maintain the switch lever 544 in the second position while printing operations are performed. Alternatively, in some instances, the impact member 556 may engage the switch lever 544 as the ribbon supply spindle 130 and the trigger 244 rotate in the second direction. In such instances, the impact member 556 may cause the switch lever 544 to move from the first position to the second position.

In some instances, the actuator 242 may be configured to generate a first signal when the switch lever 544 is in the first position and a second signal when the switch lever 544 is in the second position. The actuator 242 may be configured to communicate the first signal and the second signal to a processor or controller of a printing device (e.g., the printer 100) such that the printing device may detect or determine the orientation of the ribbon roll 136 (see FIGS. 3A and 3B). For example, one or more switch wires 558 may provide communication between the actuator 242 and the processor or controller of the printing device, or the actuator 242 may be configured to communicate wirelessly with the printing device (e.g., via Wi-Fi, Bluetooth, or other wireless communication protocols known in the art). Thus, the ribbon orientation system 540 may allow the printing device to detect an acceptable operating condition (e.g., the ribbon roll 136 is installed correctly as shown in FIG. 3A) or an unacceptable operating condition (e.g., the ribbon roll 136 is installed incorrectly as shown in FIG. 3B).

In some instances, the first signal may correspond to an acceptable operating condition, and the second signal may correspond to an unacceptable operating condition. Thus, the printing device (e.g., the printer 100) may permit printing operations to proceed in response to receiving or detecting the first signal and may disallow printing operations and/or take corrective action in response to receiving or detecting the second signal. In other instances, a reverse configuration is possible where the first signal corresponds to an unacceptable operating condition and the second signal corresponds to an acceptable operating condition.

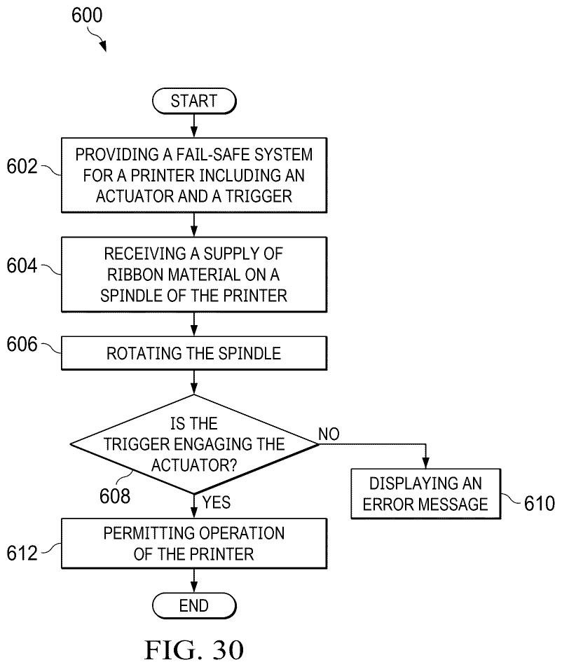

Turning to FIG. 30, a method 600 for determining whether a supply of ribbon material (e.g., ribbon roll 136) is installed on a spindle (e.g., ribbon supply spindle 130) of a printer (e.g., printer 100) correctly is depicted.

At a step 602, a ribbon orientation system (e.g., ribbon orientation system 240, 440, or 540) is provided. The ribbon orientation system includes an actuator (e.g., actuator 242) disposed adjacent to the spindle and a trigger (e.g., trigger 244) disposed on the spindle. In some instances, the trigger may rotate with the spindle and may be positioned to engage the actuator depending on the trigger's rotational position. The spindle may rotate in a first direction or a second direction, and the trigger may engage the actuator when the spindle rotates in the first direction (see, e.g., FIGS. 3A, 24, 25, 29) while the trigger may not engage the actuator when the spindle rotates in the second direction (see, e.g., FIGS. 3B, 26, 27, 28). The ribbon orientation system may generate a first signal when the trigger engages the actuator and a second signal when the trigger does not engage the actuator.

At a step 604, the supply of ribbon material is received by the spindle, for example, in response to a user placing the supply of ribbon material on the spindle.

At a step 606, the spindle is rotated. The spindle may rotate in the first direction or the second direction. The trigger rotates in the same direction as the spindle.

At a step 608, whether the actuator is engaged by the trigger is determined. In some instances, the actuator may be provided in the form of an optical sensor and the trigger may engage the actuator when a portion of the trigger is detected by the actuator (see, e.g. FIGS. 23 and 25). In some instances, the actuator may be provided in the form of a mechanical switch and the trigger may engage the actuator when a portion of the trigger impacts a portion of the actuator (see, e.g., FIG. 29). In other instances, the actuator and the trigger may be provided in any other suitable form.

At a step 610, if a determination is made that the actuator is not engaged by the trigger, the printer displays an error message (e.g., on the user interface 110) or takes other corrective action such as stopping the printer from operating.

At a step 612, if a determination is made that the actuator is engaged by the trigger, the printer is permitted to operate.

It will be appreciated by those skilled in the art that while the above disclosure has been described above in connection with particular embodiments and examples, the above disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference as if each such patent or publication were individually incorporated by reference herein. Various features and advantages of the above disclosure are set forth in the following claims.

1. A ribbon orientation system for a printer, comprising:
a spindle rotatable in a first direction and a second direction, the spindle capable of supporting a supply of ribbon material for rotation therewith;
a trigger associated with the spindle, wherein the trigger rotates with the spindle in the first direction and the second direction; and
an actuator positioned adjacent to the spindle and configured to detect whether the spindle is rotating in the first direction or the second direction via the trigger.

2. The system of claim 1, wherein the system is configured to take corrective action in the form of sending an error message in response to the actuator detecting that the spindle is rotating in the second direction.

3. The system of claim 1, further comprising:
a connection ring connected to the trigger and configured to transmit at least a portion of the rotational motion of the spindle to the trigger via friction generated by contact between at least a portion of the connection ring and at least a portion of the spindle.

4. The system of claim 1, further comprising:
an interrupter coupled to the trigger and extending outwardly therefrom, the interrupter having a first end and a second end; and
a hardstop configured to engage the first end of the interrupter when the spindle rotates in the first direction and to engage the second end of the interrupter when the spindle rotates in the second direction,
wherein engagement between the hardstop and the first end or the second end of the interrupter terminates the rotational motion of the trigger.

5. The system of claim 4, the actuator further comprising:
a passageway,
wherein the actuator is capable of detecting (i) a blocked state when an object or a portion of an object is disposed within the passageway and (ii) an unblocked state when the passageway is clear.

6. The system of claim 5, wherein the interrupter extends through the passageway and causes the actuator to detect the blocked state when the spindle rotates in the first direction and the first end of the interrupter is engaged by the hardstop, and wherein the interrupter does not extend through the passageway and the actuator detects the unblocked state when the spindle rotates in the second direction and the second end of the interrupter is engaged by the hardstop.

7. The system of claim 1, wherein the ribbon material is defined by an ink-coated side and a blank side, the ink-coated side facing away from a printhead of the printer when the spindle rotates in the first direction.

8. The system of claim 1, further comprising:
a mounting wall of the printer designed to receive a portion of the spindle;
a hardstop connected to the mounting wall; and
an actuator mounting member connected to the mounting wall and designed to support the actuator in a fixed position with respect to the spindle,
wherein the trigger is configured to engage the hardstop and to be detected by the actuator when the spindle rotates in the first direction.

9. The system of claim 1, wherein the actuator is provided in the form of an optical sensor.

10. A ribbon orientation system for a printer, comprising:
a ribbon supply spindle;
a supply of ribbon material capable of being installed on the ribbon supply spindle in a first orientation or a second orientation, the ribbon material including an ink-coated side and a blank side; and
an actuator positioned proximate to the ribbon supply spindle and configured to detect whether the supply of ribbon material is installed in the first orientation or the second orientation.

11. The system of claim 10, further comprising:
a printhead that applies heat to the ribbon material;
a platen roller positioned adjacent to the printhead; and
a waste ribbon spindle, the ribbon material guided from the ribbon supply spindle to the waste ribbon spindle along a ribbon path that passes between the printhead and the platen roller,
wherein the ink-coated side faces the platen roller when the supply of ribbon material is installed in the first orientation and the ink-coated side faces the printhead when the supply of ribbon material is installed in the second orientation.

12. The system of claim 10, wherein the actuator detects a blocked state or an unblocked state.

13. The system of claim 12, further comprising:
a trigger disposed along the spindle and capable of rotational motion.

14. The system of claim 13, further comprising:
a hardstop configured to engage the trigger and terminate rotational motion thereof,
wherein the hardstop engages a first portion of the trigger when the supply of ribbon material is installed in the first orientation, and
wherein the hardstop engages a second portion of the trigger when the supply of ribbon material is installed in the second orientation.

15. The system of claim 14, wherein the actuator is positioned to detect the trigger and the actuator detects the blocked state when the hardstop engages the first portion of the trigger.

16. The system of claim 15, wherein the system permits operation of the printer in response to the actuator detecting the blocked state.

17. The system of claim 14, wherein the actuator does not detect the trigger and the actuator detects the unblocked state when the hardstop engages the second portion of the trigger.

18. The system of claim 17, wherein the system takes corrective action in the form of stopping operation of the printer in response to the actuator detecting the unblocked state.

19. A method for determining whether a supply of ribbon material is installed on a spindle of a printer correctly, comprising the steps of:
providing a ribbon orientation mechanism comprising:
an actuator capable of being in a blocked position or an unblocked position; and
a trigger disposed on the spindle and capable of rotating in a first direction or a second direction, wherein the trigger causes the actuator to be in a blocked position when the trigger rotates in the first direction and the trigger causes the actuator to be in an unblocked position when the trigger rotates in the second direction;
receiving the supply of ribbon material on the spindle;
rotating the spindle;
determining whether the actuator is in the unblocked position or block position; and
in response to a determination that the actuator is in the unblocked position, displaying an error message.

20. The method of claim 19, further comprising the step of:
in response to a determination that the actuator is in the blocked position, permitting operation of the printer.
